(19) United States
(12) Patent Application Publication
(10) Pub. No.: US 2015/0117540 A1
(43) Pub. Date: Apr. 30, 2015

(54) CODING APPARATUS, DECODING APPARATUS, CODING DATA, CODING METHOD, DECODING METHOD, AND PROGRAM

(71) Applicant: Sony Corporation, Tokyo (JP)

(72) Inventor: Rui Morimoto, Kanagawa (JP)

(21) Appl. No.: 14/521,268

(22) Filed: Oct. 22, 2014

(30) Foreign Application Priority Data
Oct. 29, 2013 (JP) 2013-223831

(51) Int. Cl. H04N 19/513

(52) U.S. Cl. CPC H04N 19/513
USPC 375/240.16

(57) ABSTRACT

The present technology relates to a coding apparatus including a region segmentation unit that segments each of a plurality of frames in a coding target moving picture that includes the plurality of frames in a time-series order into a plurality of sub-regions having different feature amounts and provides a plurality of nodes on a boundary line of each of the sub-regions, a motion vector detector that correlates each of the plurality of nodes on a reference frame serving as a reference among the plurality of frames with an optional node on a non-reference frame other than the reference frame and detects a vector of which both ends are at the correlated node pair as a node motion vector for respective node pairs, and a coding data output unit that outputs data including the reference frame and the node motion vector as coding data obtained by coding the moving picture.

### CROSS REFERENCE TO RELATED APPLICATIONS

This application claims the benefit of Japanese Priority Patent Application JP 2013-223831 filed on Oct. 29, 2013, the entire contents of which are incorporated herein by reference.

### FIELD

The present technology relates to a coding apparatus, a decoding apparatus, coding data, a coding method, a decoding method, and a program. More specifically, the present technology relates to a coding apparatus that compresses moving picture data, a decoding apparatus, coding data, a coding method, a decoding method, and a program.

### BACKGROUND

In general, moving picture data has a large data volume and it is difficult to transmit and receive moving picture data in a non-compressed state. Thus, the moving picture data is often subjected to a compression process. This compression process may decrease the quality of moving pictures.

For example, a compression process such as H.264 which is often used currently performs coding in units of blocks having a fixed shape. Thus, the higher the compression ratio becomes, the higher the possibility of a phenomenon (so-called block noise) where a mosaic pattern appears near a block boundary becomes. Block noise occurs because the shapes of blocks are fixed regardless of a contour of an object. In order to suppress the block noise, a coding apparatus which uses a polygonal region (for example, a triangular region) called a patch as units of coding and moves the apex of the patch according to the shape of an object contour is proposed (for example, see Non Patent Literature (NPL) 1).

### CITATION LIST

### Non Patent Literature

[NPL 1] Yoshihiro Miyamoto, et al., “Warping Video Coding using Contour Adaptive Patch Structure,” Audio Visual and Multimedia Information Processing, July, 1995, p. 25 to 31

### SUMMARY

### Technical Problem

However, it is difficult in the technology of the related art to improve the quality of moving pictures. That is, in the above-described coding apparatus, the number of patches in a frame is fixed, and if the number is small, such noise that the contour of an object has angles may occur. Moreover, since the inside of an object is segmented into patches having a fixed shape, such noise as block noise may occur near the boundary of patches if the compression ratio is high. Although these kinds of noise can be suppressed using a low-pass filter or the like, if picture signals pass through the low-pass filter, the contour of an object becomes unclear and the picture quality may decrease. Thus, it is difficult to improve the quality of moving pictures.

Thus, it is desirable to improve the quality of moving pictures in view of above-described problems.

### Solution to Problem

The present technology was made to solve the above problem, and a first aspect of the present technology provides a coding apparatus including: a region segmentation unit that segments each of a plurality of frames having different feature amounts in a coding target moving picture that includes the plurality of frames in a time-series order and provides a plurality of nodes on a boundary line of each of the sub-regions; a motion vector detector that correlates each of the plurality of nodes on a reference frame serving as a reference among the plurality of frames with an optional node on a non-reference frame other than the reference frame and detects a vector of which both ends are at the correlated node pair as a node motion vector for respective node pairs; and a coding data output unit that outputs data including the reference frame and the node motion vector as coding data obtained by coding the moving picture. Further, there are provided a coding method and a program for causing a computer to execute the method. Due to this, data including the reference frame and the node motion vectors is output as coding data obtained by coding moving pictures.

In the first aspect, there may further be provided a region merging unit that acquires a vector of which both ends are at a reference coordinate serving as a reference of the sub-region on the reference frame and a reference coordinate serving as a reference of the sub-region on the non-reference frame as a region motion vector in the respective sub-regions and merges the neighboring sub-regions having the same region motion vector, and the coding data output unit may output the coding data that further includes information indicating the merged sub-region as an object region. Due to this, regions of which the region motion vectors are the same and neighbor to each other are merged.

In the first aspect, the region segmentation unit may further generate node information indicating a relative coordinate about an optional coordinate in the sub-region for the respective nodes, and the motion vector detector may calculate the distance between the relative coordinate of the node on the reference frame and the relative coordinate of the node on the non-reference frame for the respective nodes and correlates the nodes at which the distance is the smallest. Due to this, nodes at which the distance between a relative coordinate of the node on the reference frame and the relative coordinate of the node on the non-reference frame is the smallest are correlated with each other.

In the first aspect, there may further be provided a prediction frame generator that changes the positions of the plurality of nodes along the motion vector in the reference frame and generates a frame made up of new sub-regions of which the boundary lines are formed by lines on which the plurality of nodes of which the positions are changed is provided as a prediction frame obtained by predicting the non-reference frame; and a difference detecting unit that detects a difference between pixel values of corresponding pixels in the prediction frame and the non-reference frame for respective pixels, and the coding data output unit may output the coding data that further includes the difference as a prediction error in prediction of the non-reference frame. Due to this, the coding data that further includes a difference is output as the prediction error in prediction of the non-reference frame.

Further, a second aspect of the present technology provides a decoding apparatus including: a reference frame acquiring unit that acquires a reference frame from the reference frame segmented into a plurality of sub-regions in which a plurality of nodes is provided on boundary lines and a plurality of node motion vectors of which one end is at an optional one of the plurality of nodes from coding data; and a prediction frame generator that changes the positions of the plurality of nodes along the node motion vector in the reference frame and generates a frame made up of sub-regions of which the boundary lines are formed by lines on which the plurality of nodes of which the positions are changed is provided as a prediction frame obtained by predicting frames other than the non-reference frame. Further, there are provided a decoding method and a program for causing a computer to execute the method. Due to this, a frame made up of sub-regions of which the boundary lines are formed by lines on which a plurality of nodes of the reference frame, moved along the node motion vector is provided is generated as a prediction frame.

In the second aspect, there may further be provided a magnifying unit that changes the positions of the plurality of nodes in at least a portion of the reference frame and the prediction frame according to a set magnification ratio and generates a frame made up of new sub-regions of which the boundary lines are formed by lines on which the plurality of nodes of which the positions are changed is provided as a magnified frame. Due to this, a frame made up of new sub-regions of which the boundary lines are formed by lines on which a plurality of nodes moved according to a set magnification ratio is provided is generated as a magnified frame.

In the second aspect, there may further be provided a masking processor that performs mask processing to generate a frame in which the sub-region designated as a masking target in any one of the reference frame and the prediction frame is masked; and a frame combining unit that combines a combination target frame with the masked frame. Due to this, a combination target frame is combined with a mask frame obtained by masking a region designated as a masking target.

In the second aspect, there may further be provided an object recognizing unit that, when a feature amount of a recognition target object is designated, recognizes the recognition target object in the reference frame and the prediction frame based on the designated feature amount. Due to this, a recognition target object is recognized based on the feature amount.

Further, a third aspect of the present technology provides coding data that includes a reference frame segmented into a plurality of regions in which a plurality of nodes is provided on boundary lines and a plurality of node motion vectors of which one end is at an optional one of the plurality of nodes. Due to this, a frame made up of sub-regions of which the boundary lines are formed by lines on which a plurality of nodes of the reference frame, moved along the node motion vector is provided is generated as a prediction frame.

### Advantageous Effects of Invention

According to the embodiments of the present technology, the quality of moving pictures can be improved. The advantageous effects of the present technology are not limited to those described herein and may include any advantageous effects described in the present technology.

### BRIEF DESCRIPTION OF THE DRAWINGS

FIG. 1 is a block diagram illustrating a configuration example of an imaging apparatus according to a first embodiment of the present technology.

FIG. 2 is a block diagram illustrating a configuration example of a coding unit according to the first embodiment of the present technology.

FIG. 3 is a block diagram illustrating a configuration example of a region segmentation unit according to the first embodiment of the present technology.

FIG. 4 is a diagram illustrating an example of a data structure of coding data according to the first embodiment of the present technology.

FIG. 5 is a block diagram illustrating a configuration example of a decoding unit according to the first embodiment of the present technology.

FIG. 6 is a diagram illustrating an example of moving picture data before coding and coding data according to the first embodiment of the present technology.

FIGS. 7A to 7C are diagrams illustrating an example of a reference frame and a non-reference frame, nodes, and node motion vectors of respective nodes according to the first embodiment of the present technology.

FIG. 8 is a flowchart illustrating an example of a coding process according to the first embodiment of the present technology.

FIG. 9 is a flowchart illustrating an example of a region segmentation process according to the first embodiment of the present technology.

FIG. 10 is a flowchart illustrating an example of a decoding process according to the first embodiment of the present technology.

FIG. 11 is a perspective view illustrating an example of a picture processing system according to a modification of the present technology.

FIG. 12 is a block diagram illustrating an example of a picture processing system according to a modification of the present technology.

FIG. 13 is a diagram illustrating an example of a data configuration of the header of a file including coding data according to a modification of the present technology.

FIG. 14 is a diagram illustrating an example of items and descriptions of the header of a file including coding data according to a modification of the present technology.

FIG. 15 is a block diagram illustrating a configuration example of an imaging apparatus according to a second embodiment of the present technology.

FIG. 16 is a block diagram illustrating a configuration example of a resolution transform unit according to the second embodiment of the present technology.

FIGS. 17A and 17B are diagrams illustrating an example of a frame before and after magnification according to the second embodiment of the present technology.

FIG. 18 is a flowchart illustrating an example of a resolution transform process according to the second embodiment of the present technology.

FIG. 19 is a block diagram illustrating a configuration example of a region combining unit according to a third embodiment of the present technology.

FIGS. 20A and 20B are diagrams illustrating an example of a frame in which a moving object is detected according to the third embodiment of the present technology.

FIG. 21 is a diagram illustrating an example of a data structure of coding data according to the third embodiment of the present technology.

FIG. 22 is a diagram illustrating an example of a hierarchical structure of an input frame according to the third embodiment of the present technology.

FIG. 23 is a block diagram illustrating a configuration example of an image processing apparatus according to the third embodiment of the present technology.

FIGS. 24A to 24D are diagrams illustrating an example of frames before and after frame combination according to the third embodiment of the present technology.

FIG. 25 is a flowchart illustrating an example of a frame combination process according to the third embodiment of the present technology.

FIG. 26 is a block diagram illustrating a configuration example of an image processing apparatus according to a fourth embodiment of the present technology.

FIGS. 27A and 27B are diagrams for describing a retrieval process according to the fourth embodiment of the present technology.

FIG. 28 is a flowchart illustrating an example of the retrieval process according to the fourth embodiment of the present technology.

### DETAILED DESCRIPTION

Hereinafter, modes for carrying out the present technology (hereinafter, referred to as embodiments) will be described. The description will be given in the following order:

### 1. First Embodiment (Example of Generation of Coding Data Including Reference Frame and Node Motion Vector);

### 2. Second Embodiment (Example of Decoding and Magnifying Coding Data Including Reference Frame and Node Motion Vector);

### 3. Third Embodiment (Example of Decoding and Combining Coding Data Including Reference Frame and Node Motion Vector); and

### 4. Fourth Embodiment (Example of Decoding Coding Data Including Reference Frame and Node Motion Vector and

Recognizing Object)

### 1. First Embodiment

### [Configuration Example of Imaging Apparatus]

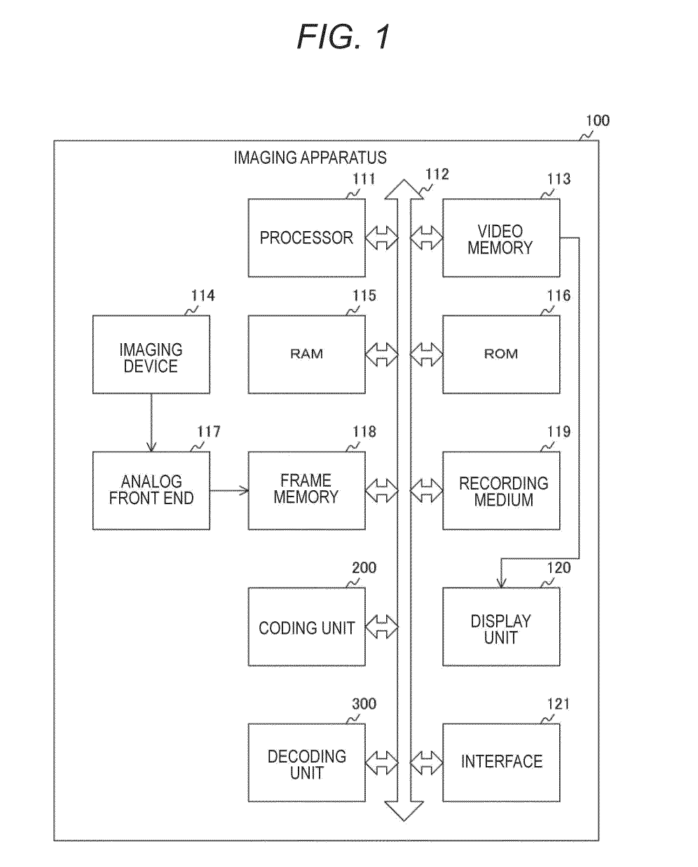

FIG. 1 is a block diagram illustrating a configuration example of an imaging apparatus 100 according to a first embodiment of the present technology. The imaging apparatus 100 is an apparatus that images a moving picture that includes a plurality of pictures in a time-series order. The imaging apparatus 100 includes a processor 111, a bus 112, a video memory 113, an imaging device 114, a random access memory (RAM) 115, a read only memory (ROM) 116, and an analog front end 117. Moreover, the imaging apparatus 100 includes a frame memory 118, a recording medium 119, a display unit 120, an interface 121, a coding unit 200, and a decoding unit 300.

The processor 111 is configured to control the entire imaging apparatus 100. The bus 112 is a common path through which data is exchanged between the processor 111, the video memory 113, the RAM 115, the ROM 116, the frame memory 118, the recording medium 119, the interface 121, the coding unit 200, and the decoding unit 300.

The video memory 113 is configured to store data displayed on the display unit 120. The display unit 120 is configured to display data stored in the video memory 113. The RAM 115 is used as a program executed by the processor 111 and a work area for temporarily storing data necessary for processes. The ROM 116 is configured to record the program and the like executed by the processor 111.

The imaging device 114 is configured to image an imaging object to generate an analog picture signal. The imaging device 114 supplies the generated picture signal to the analog front end 117. The analog front end 117 is configured to transform the analog picture signal to digital picture data (hereinafter referred to as a “frame”). Here, the frame includes a plurality of pixels arranged in a two-dimensional lattice form. Moreover, the analog front end 117 performs noise-reduction processing and demosaic processing such as correlated double sampling (CDS) on frames and stores the frames in the frame memory 118. The frame memory 118 is configured to store the frames supplied from the analog front end 117.

The coding unit 200 is configured to code moving picture data including a plurality of frames in a time-series order. Here, “coding” means compressing moving picture data. The coding unit 200 reads frames from the frame memory 118 in order via the bus 112 to acquire the moving picture data including the frames. The coding unit 200 codes the moving picture data to generate coding data. Moreover, the coding unit 200 supplies the coding data to the recording medium 119 or the interface 121 via the bus 112. Although the coding unit 200 acquires the moving picture data from the frame memory 118, the coding unit 200 may acquire the moving picture data from the recording medium 119 or the interface 121 instead of from the frame memory 118.

The decoding unit 300 is configured to decode coding data. The decoding unit 300 acquires coding data from the recording medium 119 or the interface 121 via the bus 112. Moreover, the decoding unit 300 decodes the coding data to original moving picture data before coding. The decoding unit 300 supplies the decoded moving picture data to any one of the video memory 113, the recording medium 119, and the interface 121.

The recording medium 119 is configured to record coding data or moving picture data. For example, an SD card (the registered trademark), a memory stick (the registered trademark), a hard disk drive (HDD), or the like is used as the recording medium 119. The interface 121 is configured to transmit and receive data such as coding data or moving picture data to and from an external device of the imaging apparatus 100. For example, an interface such as a high-definition multimedia interface (HDMI: registered trademark) or a universal serial bus (USB) is used as the interface 121. The interface 121 may be an optional interface compatible with a cable communication standard or a radio communication standard as long as the interface can transmit and receive data to and from an external device. For example, the interface 121 may be an interface compatible with IEEE (Institute of Electrical and Electronics Engineers) 1394. Moreover, the interface 121 may be an interface compatible with Serial ATA (Advanced Technology Attachment), Thunderbolt (the registered trademark), or Ethernet (the registered trademark). Moreover, the interface 121 may be an interface compatible with wireless HDMI (the registered trademark) or IEEE 802.11a/b/g/ac. Further, the interface 121 may be an interface compatible with CDMA (Code Division Multiple Access) or LTE (Long Term Evolution). Further, the interface 121 may be an interface compatible with WiMAX (Worldwide Interoperability for Microwave Access). Further, the interface 121 may be an interface compatible with XGP (eXtended Global Platform) or HSPA (High Speed Packet Access). Further, the interface 121 may be an interface compatible with DC-HSDPA (Dual Cell High Speed Downlink Packet Access).

Moreover, although the imaging apparatus 100 is configured such that the imaging device 114, the analog front end 117, and the coding unit 200 are provided in the same apparatus, the present technology is not limited to this configuration. These constituent components may be provided in different apparatuses. For example, the imaging device 114 and the analog front end 117 may be provided in an imaging apparatus, and the coding unit 200 may be provided in an information processing apparatus (personal computer or the like). In this configuration, the imaging apparatus performs imaging to obtain moving picture data and transmits the moving picture data to the information processing apparatus and the information processing apparatus performs coding. Moreover, the coding unit 200 and the decoding unit 300 may be provided in different apparatuses.

Moreover, the imaging apparatus 100 is an example of a coding apparatus described in the claims. Further, the imaging apparatus 100 is an example of a decoding apparatus described in the claims.

### [Configuration Example of Coding Unit]

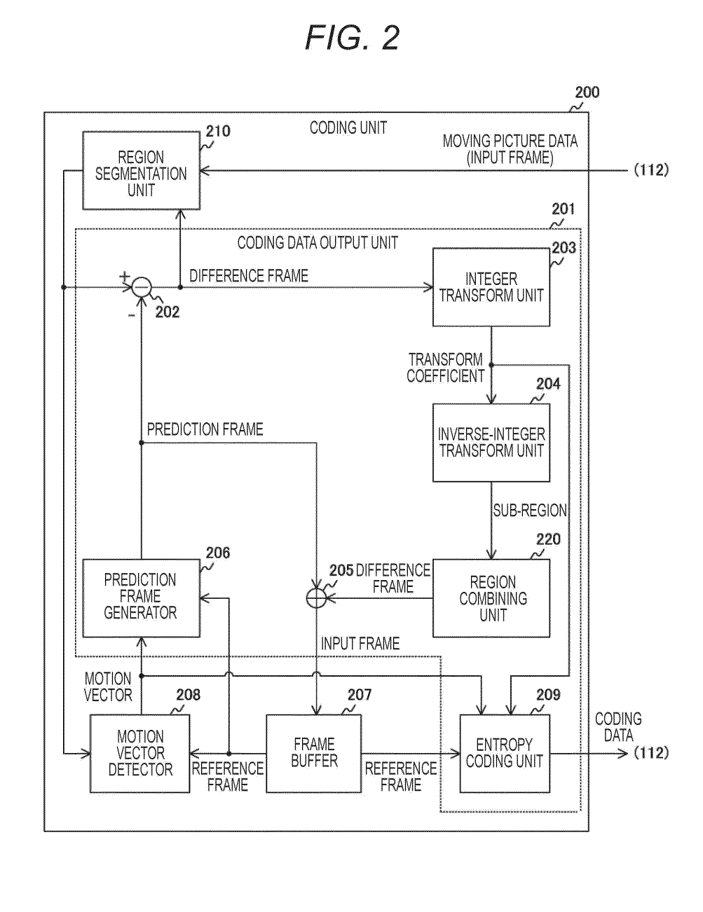

FIG. 2 is a block diagram illustrating a configuration example of the coding unit 200 according to the first embodiment of the present technology. The coding unit 200 includes a region segmentation unit 210, a coding data output unit 201, a motion vector detector 208, and a frame buffer 207.

The coding data output unit 201 is configured to output coding data obtained by coding moving picture data. The coding data output unit 201 includes a subtractor 202, an integer transform unit 203, an inverse-integer transform unit 204, an adder 205, a prediction frame generator 206, an entropy coding unit 209, and a region combining unit 220.

The region segmentation unit 210 is configured to acquire a plurality of frames from the bus 112 as input frames and to segment each of the input frames into a plurality of regions having different feature amounts. Here, for example, colors, contrast, and the like are used as the feature amount. A technique of segmenting one frame into a plurality of regions based on the feature amount is referred to as region segmentation. Respective regions obtained by region segmentation are referred to as “sub-regions”.

In region segmentation, if the color space of a frame is a RGB (Red-Green-Blue) color space, the region segmentation unit 210 transforms the color space into a HSV (Hue-Saturation-Value) color space (hereinafter this transform is referred to as “HSV transform”). Moreover, the region segmentation unit 210 performs a color reduction process on the HSV transformed frame. In the color reduction process, 256 colors are reduced to 16 colors, for example. Although the algorithm becomes simplest if binarization of reducing the number of colors to two colors is performed as the color reduction process, it is not desirable because binarization results in a very large spatial change in colors and gradations. Moreover, the region segmentation unit 210 extracts a feature amount of each pixel in the color-reduced frame and performs pixel clustering using the K-means algorithm based on the feature amount. The K-means algorithm is an algorithm of classifying pixels into K (K is an integer) clusters using the mean of the feature amounts of a cluster.

In the K-means algorithm, first, respective pixels are randomly allocated to K clusters. Moreover, the region segmentation unit 210 calculates the means of feature amounts of respective clusters as a center of the cluster.

After the means are calculated, the region segmentation unit 210 calculates an Euclid distance between the feature amount of each pixel and each mean and reallocates pixels to a cluster having the smallest Euclid distance. The region segmentation unit 210 ends the K-means algorithm if the number of reallocated pixels is smaller than a threshold and returns to the mean calculating process if not.

The region segmentation unit 210 sets an initial value (for example, “2”) to K and classifies pixels into K clusters using the K-means algorithm. Moreover, the region segmentation unit 210 repeatedly executes clustering based on the K-means algorithm while incrementing K until predetermined termination conditions are satisfied. Here, the termination conditions are satisfied, for example, if the number of clusters exceeds an upper limit (for example, “12”) or if the proportion (error ratio) of clusters in which pixels are reallocated is smaller than an allowable proportion (for example, 5%). With this clustering, the input frame is segmented into a plurality of regions having an optional shape so that the respective regions have a uniform feature amount.

As described above, the region segmentation unit 210 performs the region segmentation process by executing HSV transform, the color reduction process, and the clustering process based on the K-means algorithm in order. According to the region segmentation process including the color reduction process, since the frequency of a spatial change in colors and gradations in a sub-region decreases, the fitting accuracy of the process of the integer transform unit 203 described later is improved. Details of this process are described in “S. Sural, et al., “Segmentation and histogram generation using the hsv color space for image retrieval,” 2002 Proc. of Int'l Conf. on Image Process, 2 (2002), p. 589″. Although the region segmentation unit 210 performs region segmentation via the HSV transform, the color reduction process, and the clustering process, the present technology is not limited to this configuration. A method in which clustering is performed without performing the color reduction process after the HSV transform may be used. Details of this method are described in “M. Luo et al., “A Spatial Constrained K-Means Approach to Image Segmentation,” Proc. of ICICS-PCM 2003, 2 (2003), p. 738”.

Moreover, the region segmentation unit 210 may perform region segmentation by performing the clustering process only without performing the HSV transform and the color reduction process. Alternatively, the region segmentation unit 210 may perform region segmentation by performing the HSV transform and the color reduction process (binarization or the like) without performing the clustering process. As described above, various region segmentation methods are known, and the method may be selected from the perspective of a balance with a processing speed.

The region segmentation unit 210 assigns a region ID (IDentification code) for identifying each of the segmented sub-regions. Moreover, the region segmentation unit 210 calculates a reference coordinate serving as a reference of each sub-region. The coordinate of the center of a sub-region, for example, is calculated as the reference coordinate. The region segmentation unit 210 generates information including the region ID and the reference coordinate of each sub-region as region information and adds the region information to the input frame.

Moreover, the region segmentation unit 210 provides a plurality of nodes on respective boundary lines of the sub-region. For example, the region segmentation unit 210 approximates the boundary lines of a sub-region to a polygon and provides nodes at apexes of the polygon. Although the region segmentation unit 210 provides nodes based on polygonal approximation, the present technology is not limited to this configuration. For example, the region segmentation unit 210 may segment a boundary line into a plurality of segments at predetermined intervals and may use the segmented points as nodes.

The region segmentation unit 210 assigns a node ID for identifying each of the nodes. Moreover, the region segmentation unit 210 correlates the sub-region with nodes on the boundary lines of each region. The region segmentation unit 210 generates information including the node ID and the node coordinate of each node as node information and adds the node information to the input frame. Here, the node coordinate is represented by a relative coordinate about the reference coordinate of the sub-region.

The region segmentation unit 210 supplies the input frame to which the region information and the node information are added to the coding data output unit 201 and the motion vector detector 208.

The motion vector detector 208 is configured to detect a node motion vector at each node. First, the motion vector detector 208 acquires the reference frame from the frame buffer 207. The reference frame is a frame used as a reference in motion prediction, and one frame in each group made up of a plurality of (for example, “15”) frames of a moving picture is acquired as the reference frame.

Moreover, the motion vector detector 208 acquires non-reference frames other than the reference frame among the input frames from the region segmentation unit 210. The motion vector detector 208 correlates an optional sub-region on the non-reference frame with each of the plurality of sub-regions on the reference frame based on a similarity of sub-regions.

The same region ID as the region ID of a sub-region in the reference frame correlated based on a similarity is assigned to each sub-region of the non-reference frame. However, a case where it is not possible to correlate a sub-region in the non-reference frame with the sub-region in the reference frame may occur. In this case, the motion vector detector 208 negates the region ID of the sub-region which is not correlated and assigns a new region ID.

The similarity of sub-regions is calculated according to SSD (Sum of Squared Difference) or SAD (Sum of Absolute Difference), for example. The former is the sum of squared difference of pixel values of corresponding pixels and the latter is the sum of absolute difference of pixel values of corresponding pixels.

Specifically, the motion vector detector 208 uses an optional sub-region in the reference frame as a target region and sets a search region having a fixed shape in the non-reference frame. Here, the search region is a region for searching for a corresponding sub-region in the non-reference frame, and a range of M×M pixels (M is an integer of 2 or more) about the reference coordinate of the target region, for example, is set as the search region. The motion vector detector 208 calculates pixels of which the relative coordinates are the same as those of pixels in the target region in each of the sub-regions to which the reference coordinate in the search region belongs as corresponding pixels. Moreover, the motion vector detector 208 calculates the sum (SSD) of squared differences of pixel values of the corresponding pixels or the sum (SAD) of absolute differences of pixel values of corresponding pixels as the similarity.

The motion vector detector 208 acquires a sub-region having the highest similarity in the search region as a sub-region corresponding to the target region. Moreover, the motion vector detector 208 correlates each of the plurality of nodes on the boundary lines of the target region with a node at a point coordinate at which the distance is the smallest among the nodes on the boundary lines of a sub-region corresponding to the target region. The same node ID as the node ID of the node in the reference frame correlated based on the similarity is assigned to the respective nodes of the non-reference frame. However, there may be a case where it is not possible to correlate nodes in the non-reference frame with the node in the reference frame. In this case, the motion vector detector 208 negates the node ID of the node which is not correlated and assigns a new node ID. The motion vector detector 208 calculates a vector of which both ends are the correlated node pair as a node motion vector for each node pair. The motion vector detector 208 supplies node information to which the calculated node motion vector is added to the prediction frame generator 206 and the entropy coding unit 209. A process of calculating the motion vector from the reference frame and the non-reference frame in this manner is referred to as a motion prediction.

Here, it is assumed that the reference frame is a frame older than the non-reference frame in the time-series order. Motion prediction of calculating a motion vector of a non-reference frame from an older reference frame in this manner is referred to as forward prediction. On the other hand, motion prediction of calculating a motion vector of the non-reference frame from a reference frame using a frame later than the non-reference frame as the reference frame is referred to as backward prediction. The motion vector detector 208 may perform backward prediction instead of forward prediction and may perform both forward prediction and backward prediction. Moreover, although the motion vector detector 208 calculates SSD or SAD to correlates sub-regions, the present technology is not limited to this configuration. For example, the motion vector detector 208 may perform coding using the coordinates of respective nodes on a sub-region and a cluster center such as a SIFT (Scale-Invariant Feature Transform) feature amount or a color vector in which the color information within a sub-region is determined in advance. Moreover, the motion vector detector 208 may perform clustering based on the K-means technique with respect to these sub-regions. Details thereof are described in “Lowe, D.G., “Object recognition from local scale invariant features,” Proc. of IEEE International Conference on Computer Vision (1999), pp. 1150-1157”. In this case, sub-regions belonging to the same cluster are correlated preferentially, and the same region ID is assigned to the corresponding sub-regions. According to this method, it is possible to extract sub-regions to which the same region ID is to be assigned with high probability.

The prediction frame generator 206 is configured to generate a prediction frame obtained by predicting a non-reference frame based on the reference frame and the node motion vector. The prediction frame generator 206 acquires the reference frame from the frame buffer 207 and moves nodes on the boundary lines of each of the sub-regions in the reference frame along the node motion vector corresponding to each of the nodes. The prediction frame generator 206 generates a region surrounded by the nodes moved along the node motion vector as a sub-region of the prediction frame. Segments between nodes are interpolated by a linear interpolation algorithm, for example. The prediction frame generator 206 may interpolate segments between nodes by an interpolation algorithm other than linear interpolation (for example, algorithms such as spline interpolation or Bezier interpolation).

The feature amount (colors or the like) in the sub-region in the prediction frame is set to be the same as that of the corresponding sub-region in the reference frame. A process of generating a non-reference frame from the reference frame and the node motion vector in this manner is referred to as a motion compensation process. The prediction frame generator 206 supplies the prediction frame made up of the generated sub-regions to the subtractor 202 and the adder 205.

The subtractor 202 is configured to calculate a difference between an input frame and the prediction frame corresponding to the input frame. The subtractor 202 calculates the difference between the pixel value of each of the pixels in the input frame and the pixel value of each of the pixels in the prediction frame corresponding to the pixel and supplies a frame made up of such differences to the integer transform unit 203 as a difference frame. This difference frame represents a prediction error in prediction of the non-reference frame. Moreover, the subtractor 202 supplies the difference frame to the region segmentation unit 210 as necessary. Specifically, when the region segmentation unit 210 changes the termination conditions based on the prediction error, the difference frame is supplied to the region segmentation unit 210.

The integer transform unit 203 is configured to integer transform with respect to each of the sub-regions. Here, integer transform means transforming (orthogonally transforming) a video signal of a sub-region into a frequency component with integer accuracy. For example, DCT (Discrete Cosine Transform) or DHT (Discrete Hadamard Transform) is used as orthogonal transform. The integer transform unit 203 transforms the sub-region into a DC component according to an integer-accuracy DCT and performs DHT on the DC component as necessary. The integer transform unit 203 supplies a transform coefficient obtained by orthogonal transform to the inverse-integer transform unit 204 and the entropy coding unit 209.

Although the coding unit 200 performs integer transform on the sub-regions, the present technology is not limited to this configuration. The coding unit 200 may transform the sub-regions into a frequency component according to a real-number-accuracy DCT. Moreover, the coding unit 200 may use an optional transform scheme other than integer transform or DCT as long as the sub-regions are fit into frequency components. For example, the coding unit 200 may perform transform according to a power function or a Fluency function. Although a fitting target sub-region is a region having a free boundary rather than having a fixed shape such as a block, a remarkable problem may not occur if coordinates are added or coordinate transform is performed so that the sub-regions have a rectangular shape.

The inverse-integer transform unit 204 is configured to transform the transform coefficient to original sub-regions before the integer transform. The inverse-integer transform unit 204 supplies the transformed sub-regions to the region combining unit 220.

The region combining unit 220 is configured to combine sub-regions to generate a difference frame. The region combining unit 220 supplies the generated difference frame to the adder 205.

The adder 205 is configured to add a difference frame corresponding to a prediction frame to the prediction frame. The adder 205 calculates the sums of the pixel values of each of the pixels in the prediction frame and the pixel values of each of the pixels in the difference frame corresponding to the pixel and stores a pixel frame made up of the sums in the frame buffer 207 as an input frame. The frame buffer 207 is configured to store input frames.

The entropy coding unit 209 codes the reference frame and the transform coefficient according to entropy coding. The entropy coding unit 209 acquires the reference frame from the frame buffer 207 and codes the reference frame and the transform coefficient into entropy codes to generate coding data. Huffman codes are used as the entropy codes, for example. The entropy codes may be arithmetic codes. The entropy coding unit 209 supplies the generated coding data to the bus 112.

Although the coding data output unit 201 codes the transform coefficient indicating a prediction error in addition to the reference frame and the node motion vector, the transform coefficient may not be coded but the reference frame and the node motion vector only may be coded. If moving picture data is computer graphics (CG) data or animation data which has a small prediction error, it is possible to reduce the amount of data while maintaining the quality of moving pictures even if the transform coefficient is not coded.

Moreover, the coding unit 200 may set a new reference frame based on the amount of data in the difference frame. For example, when the amount of data in the difference frame in relation to the non-reference frame exceeds an allowable value, the coding unit 200 sets the non-reference frame as a new reference frame. The coding unit 200 correlates regions and nodes in the new reference frame and the non-reference frame and reassigns region IDs and node IDs.

Moreover, although the region segmentation unit 210 uses fixed termination conditions for clustering in the region segmentation regardless of the prediction error, the region segmentation unit 210 may change the termination conditions based on the prediction error. In this case, the region segmentation unit 210 acquires difference data or the transform coefficient as the prediction error and changes the termination conditions so that the number of segmented regions corresponding to the prediction error is obtained. Specifically, the region segmentation unit 210 changes the termination conditions so that the larger the prediction error is, the larger the number of clusters in the termination conditions is whereas the smaller the prediction error is, the smaller the upper limit is. Alternatively, the region segmentation unit 210 changes the termination conditions so that the larger the prediction error is, the smaller the allowable proportion to the error ratio in the termination conditions is whereas the smaller the prediction error is, the larger the allowable proportion is. Alternatively, the region segmentation unit 210 changes both the upper limit and the allowable proportion. In this way, the region segmentation unit 210 can segment the input frame into an appropriate number of regions.

Moreover, when the amount of data in the difference frame exceeds an allowable value, the region segmentation unit 210 may repeatedly perform the region segmentation process on a partial block in the non-reference frame corresponding to the difference frame. For example, the region segmentation unit 210 extracts a partial block only in which the prediction error in the difference frame where the amount of data exceeds the allowable value is larger than a predetermined value. Moreover, the region segmentation unit 210 resegments a target block in a non-reference frame corresponding to the difference frame using the extracted block only as the target block and reassigns IDs to newly generated sub-regions and nodes in the target block. In this case, since it is not necessary to reassign IDs to sub-regions present outside the target block in the non-reference frame and nodes included in the sub-regions, it is possible to shorten the processing time as compared to setting a new reference frame and performing a region segmentation process on the entire region again.

### [Configuration Example of Region Segmentation Unit]

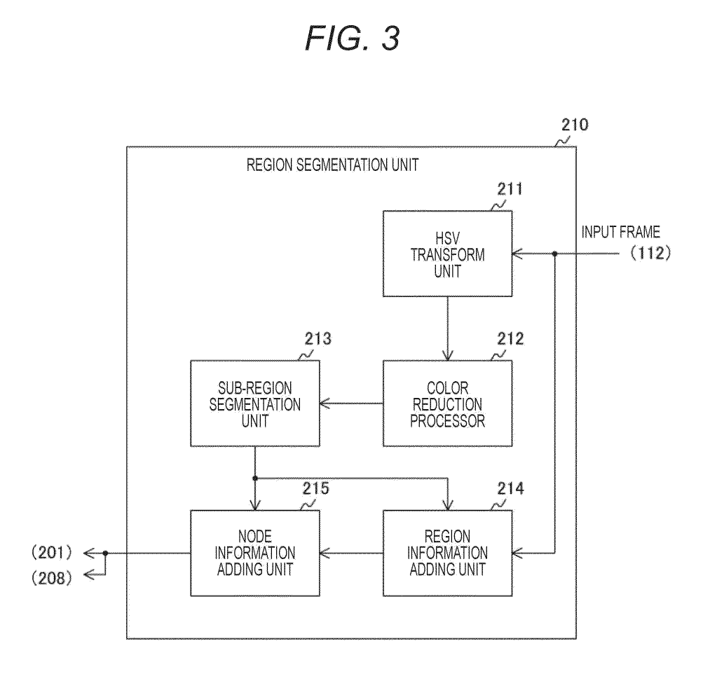

FIG. 3 is a block diagram illustrating a configuration example of the region segmentation unit according to the first embodiment of the present technology. The region segmentation unit 210 includes a HSV transform unit 211, a color reduction processor 212, a sub-region segmentation unit 213, a region information adding unit 214, and a node information adding unit 215.

The HSV transform unit 211 is configured to perform HSV transform on the input frame. The HSV transform unit 211 supplies the HSV input frame to the color reduction processor 212.

The color reduction processor 212 is configured to perform a color reduction process on the input frame supplied from the HSV transform unit 211. The color reduction processor 212 supplies the input frame obtained by the color reduction process to the sub-region segmentation unit 213.

The sub-region segmentation unit 213 is configured to segment the input frame obtained after the color reduction process into a plurality of regions having different feature amounts. The sub-region segmentation unit 213 supplies the segmented input frame to the region information adding unit 214 and the node information adding unit 215.

The region information adding unit 214 is configured to add region information to the input frame before the HSV transform. The region information adding unit 214 assigns a region ID unique in the input frame to the respective segmented sub-regions, calculates a reference coordinate of each sub-region, generates region information including the region ID and a reference coordinate, and adds the region information to the input frame. The region information adding unit 214 supplies the input frame to which the region information is added to the node information adding unit 215.

The node information adding unit 215 is configured to further add node information to the input frame to which the region information is added. The node information adding unit 215 provides a plurality of nodes on boundary lines of each of the sub-regions and assigns a region ID unique in the input frame to respective nodes. The node information adding unit 215 generates node information including the node ID and a node coordinate for each node and adds the node information to the input frame. The node information adding unit 215 supplies the input frame to which the node information is added to the coding data output unit 201 and the motion vector detector 208.

### [Configuration Example of Coding Data]

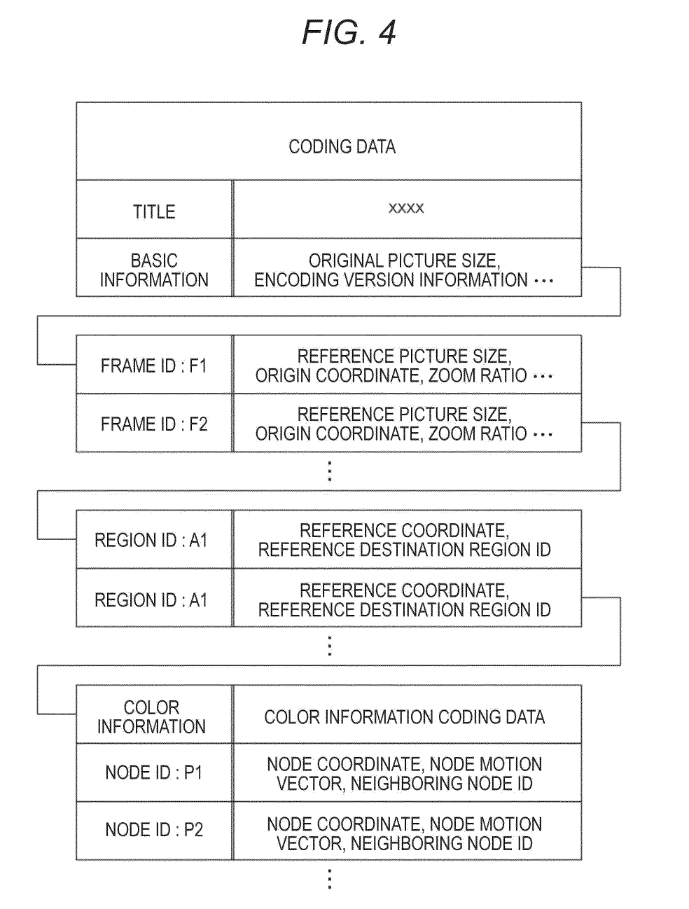

FIG. 4 is a diagram illustrating an example of a data structure of the coding data according to the first embodiment of the present technology. The coding data includes a title and basic information. The basic information is information on moving picture data and stores the size of an original picture and encode version information.

The frame information of each of the input frames is stored in correlation with the basic information. Each of the items of frame information includes a frame ID, a reference picture size, an origin coordinate, a zoom ratio, and the like. The frame ID is information for identifying a frame and information unique in a moving picture is assigned. The title, the basic information, and the frame information are included in advance in the original moving picture data before coding.

The region information of each of the plurality of sub-regions in the input frame indicated by the frame information is stored in correlation with each of the items of frame information. Each of the items of region information of the non-reference frame includes a region ID, a reference coordinate, and a reference destination region ID. Here, the reference destination region ID of the non-reference frame is a region ID of a correlated sub-region of the reference frame in the same group. On the other hand, an invalid value is set to the reference destination region ID of the reference frame. One region ID is set to respective reference destination region IDs. For example, if the reference destination region ID of a sub-region of which the region ID of a certain non-reference frame is “A1” is “A2,” a sub-region on a reference frame corresponding to the sub-region “A1” of the non-reference frame is the sub-region “A2”.

The region ID and the reference coordinate in the region information are generated by the region segmentation unit 210. Moreover, the reference destination region ID is generated by the motion vector detector 208. Moreover, the region information is coded by the entropy coding unit 209, but the data before coding is described in FIG. 4 for the sake of convenience.

Moreover, the node information and the color information of each of a plurality of nodes on the boundary lines of a region indicated by the region information are stored in correlation with the region information of the reference frame. On the other hand, only the node information is correlated with the region information of the non-reference frame. Each of the items of node information includes a node ID, a node coordinate, a node motion vector, and a neighboring node ID. However, a zero vector is set to the node motion vectors of all nodes in the reference frame. Moreover, an invalid value is set to all node coordinates in the non-reference frame. Here, the neighboring node IDs are node IDs of neighboring nodes. A plurality of node IDs is set to the neighboring node IDs. For example, if the neighboring node IDs of a node having the node ID “P1” are “P2” and “P3,” the node of “P1” is connected to the nodes of “P2” and “P3”. Moreover, a segment connecting “P1” and “P2” and a segment connecting “P1” and “P3” are depicted as segments on a boundary line.

In the node information, the node ID, the node coordinate, and the neighboring node ID are generated by the region segmentation unit 210. Moreover, the node motion vector is generated by the motion vector detector 208. Moreover, the node information is coded by the entropy coding unit 209, but the data before coding is described in FIG. 4 for the sake of convenience.

The color information is data of an entropy-coded sub-region. This color information is generated by the entropy coding unit 209. Although a transform coefficient is further stored in correlation with each of the non-reference frames, the transform coefficient is omitted in FIG. 4.

### [Configuration Example of Decoding Unit]

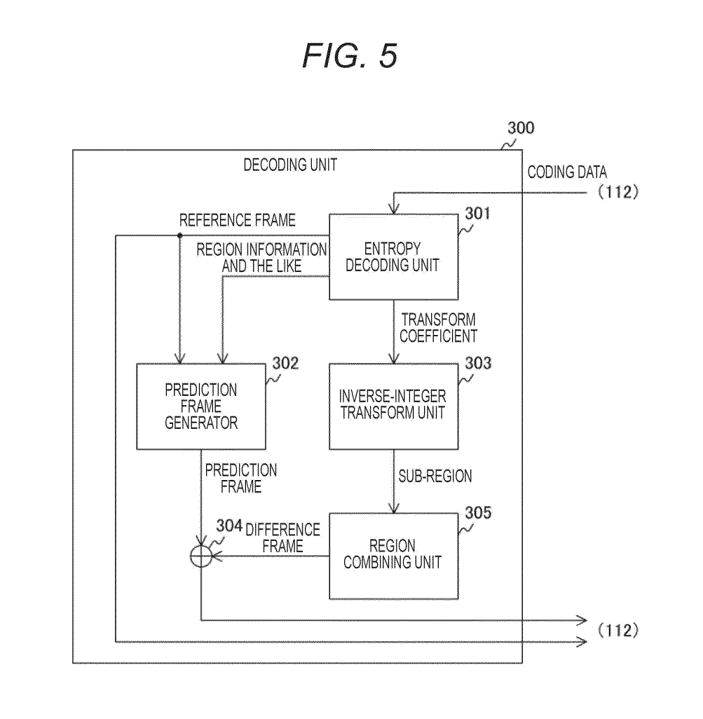

FIG. 5 is a block diagram illustrating a configuration example of the decoding unit 300 according to the first embodiment of the present technology. The decoding unit 300 includes an entropy decoding unit 301, a prediction frame generator 302, an inverse-integer transform unit 303, an adder 304, and a region combining unit 305. The entropy decoding unit 301 is configured to decode coding data using a decoding algorithm corresponding to the entropy coding algorithm. With this decoding, the reference frame, the region information and the node information of the non-reference frame, and the transform coefficient are obtained. The region information and the node information of the reference frame are added to the reference frame. The entropy decoding unit 301 supplies the reference frame to the bus 112 and the prediction frame generator 302 and supplies the region information and the node information of the non-reference frame to the prediction frame generator 302. Moreover, the entropy decoding unit 301 supplies the transform coefficient to the inverse-integer transform unit 303. The entropy decoding unit 301 is an example of a reference frame acquiring unit described in the claims. The prediction frame generator 302 has the same configuration as the prediction frame generator 206 of the coding unit 200. The frame information, the region information, and the node information are added to the generated prediction frame. The coordinate of the node of the reference frame moved along the node motion vector of the non-reference frame is set to the node coordinate of the node information. The prediction frame generator 302 supplies the prediction frames to the adder 304. The inverse-integer transform unit 303 has the same configuration as the inverse-integer transform unit 204 of the coding unit 200. The inverse-integer transform unit 303 supplies the generated sub-regions to the region combining unit 305.

The region combining unit 305 has the same configuration as the region combining unit 220 of the coding unit 200. The region combining unit 220 supplies the generated difference frames to the adder 304. The adder 304 has the same configuration as the adder 205 of the coding unit 200. The adder 304 supplies the generated input frames to the bus 112.

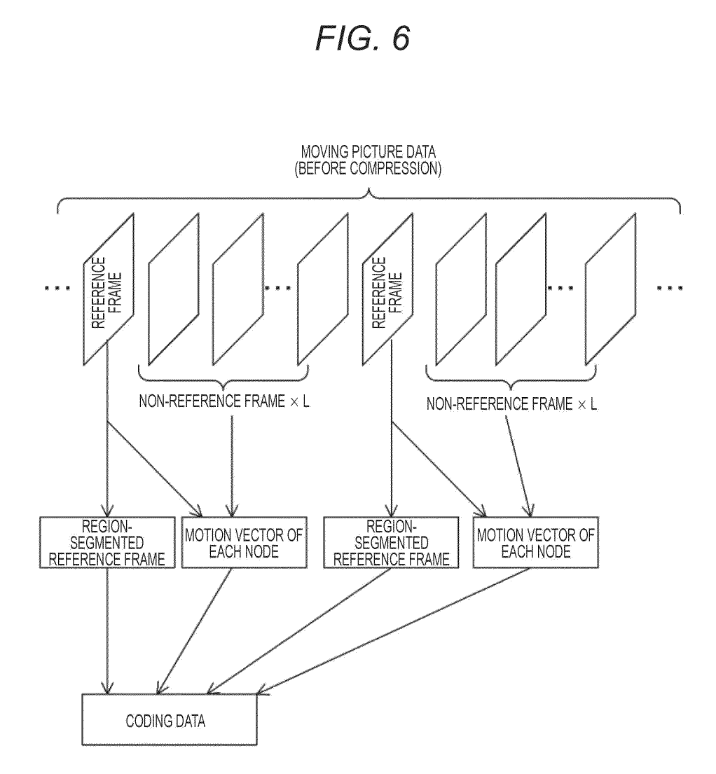

FIG. 6 is a diagram illustrating an example of moving picture data before coding and coding data according to the first embodiment of the present technology. The moving picture data includes a plurality of input frames in a time-series order. Moreover, one reference frame is included in each group made up of (L+1) input frames (L is an integer). In this group, L input frames other than the reference frame are treated as non-reference frames. These frames are subjected to region segmentation by the region segmentation unit 210 and node motion vectors of the nodes are calculated by the motion vector detector 208. Moreover, data including the region-segmented reference frame and the node motion vectors is coded by the entropy coding unit 209 whereby coding data is generated. In general, the amount of data of the node motion vector is very smaller than the amount of data of the non-reference frame. Thus, the amount of data of the coding data obtained by coding the node motion vector instead of the non-reference frame is very smaller than that of the moving picture data.

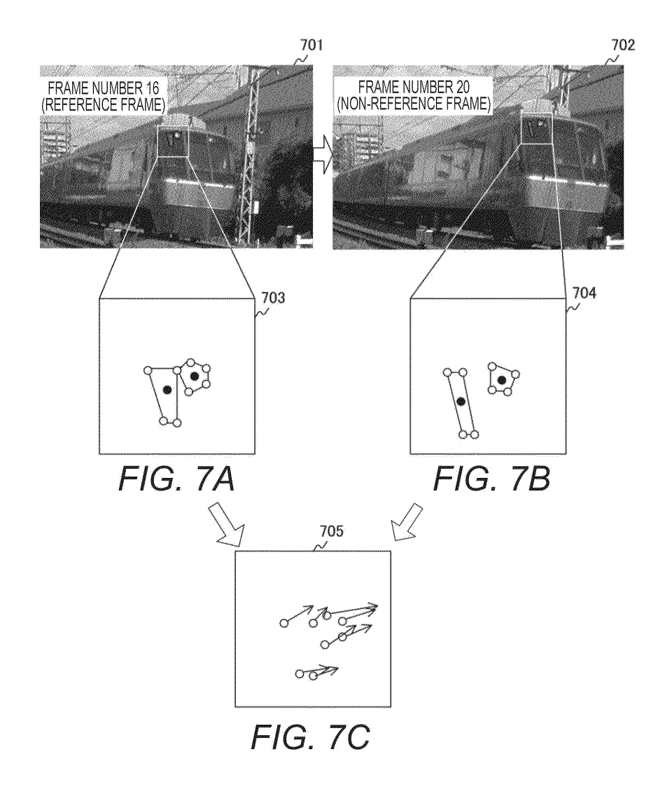

FIGS. 7A to 7C are diagrams illustrating an example of a reference frame and a non-reference frame, nodes, and node motion vectors of respective nodes according to the first embodiment of the present technology. FIG. 7A illustrates an example of a reference frame 701. The reference frame 701 is segmented into a plurality of sub-regions after the HSV transform process and the color reduction process are performed. For the sake of convenience, the frames after the HSV transform process and the color reduction process are performed are omitted. A rectangular region 703 which is an enlarged view of a portion of the reference frame 701 includes a tetragonal sub-region and a pentagonal sub-region. Sub-regions other than these sub-regions are omitted. Nodes represented by white circles are provided at apexes of the sub-regions. Moreover, the coordinates of the black circles in the rectangular region 703 represent the reference coordinates of the sub-regions.

FIG. 7B illustrates an example of a non-reference frame 702. The non-reference frame 702 is segmented into a plurality of sub-regions after the HSV transform process and the color reduction process are performed. A rectangular region 704 which is an enlarged view of a portion of the non-reference frame 702 includes two tetragonal sub-regions. Nodes are provided at apexes of the sub-regions.

FIG. 7C illustrates an example of a node motion vector. Nodes in the rectangular regions 704 correspond to the nodes in the rectangular regions 703 in one-to-one correspondence. Moreover, a vector of which both ends are at the corresponding nodes is detected as a node motion vector. For example, a node motion vector of which the starting point is at a node in the reference frame and the ending point is at a node in the non-reference frame is detected.

In this manner, the coding unit 200 calculates a node motion vector of each node on the boundary line of the sub-region, whereby the decoding unit 300 can predict the shape of a sub-region after change from the node motion vector even if the shape of the sub-region changes between input frames.

### [Operation Example of Imaging Apparatus]

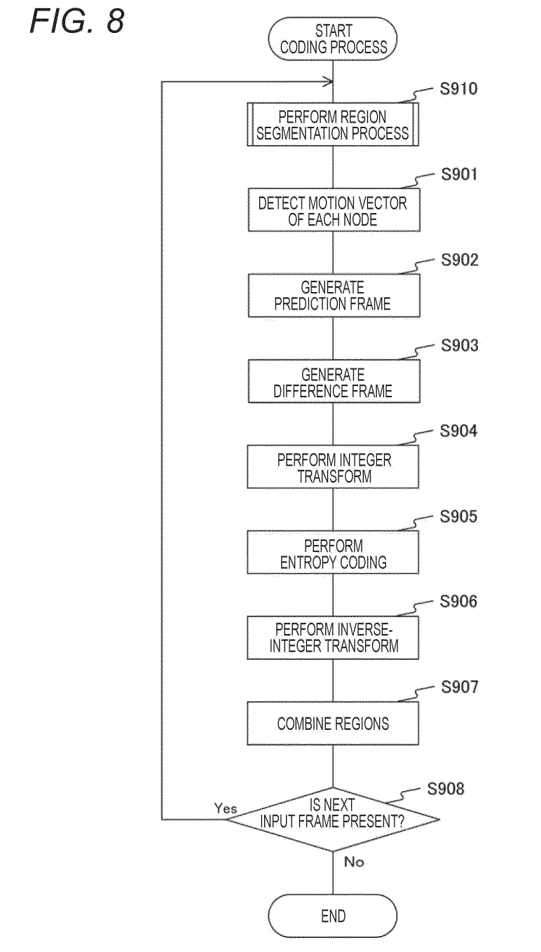

FIG. 8 is a flowchart illustrating an example of a coding process according to the first embodiment of the present technology. This coding process starts, for example, when moving picture data is input to the coding unit 200. The coding unit 200 executes a region segmentation process of segmenting an input frame into a plurality of regions (step S910). The coding unit 200 detects a node motion vector of each node from the reference frame and the non-reference frame (step S901). The coding unit 200 generates a prediction frame from the reference frame and the node motion vector (step S902). Moreover, the coding unit 200 generates a difference frame between the prediction frame and the non-reference frame (step S903). The coding unit 200 performs integer transform on the difference frame for respective sub-regions (step S904) and performs entropy coding on the reference frame and the node motion vector (step S905). The coding unit 200 performs inverse-integer transform on the integer-transformed data to generate original sub-regions (step S906). Moreover, the coding unit 200 combines the sub-regions to generate a difference frame and generates an input frame from the difference frame and the prediction frame (step S907). The coding unit 200 determines whether the next input frame is present (step S908). The coding unit 200 returns to step S910 when the next input frame is present (Yes in step S908) and ends the coding process if not (No in step S908).

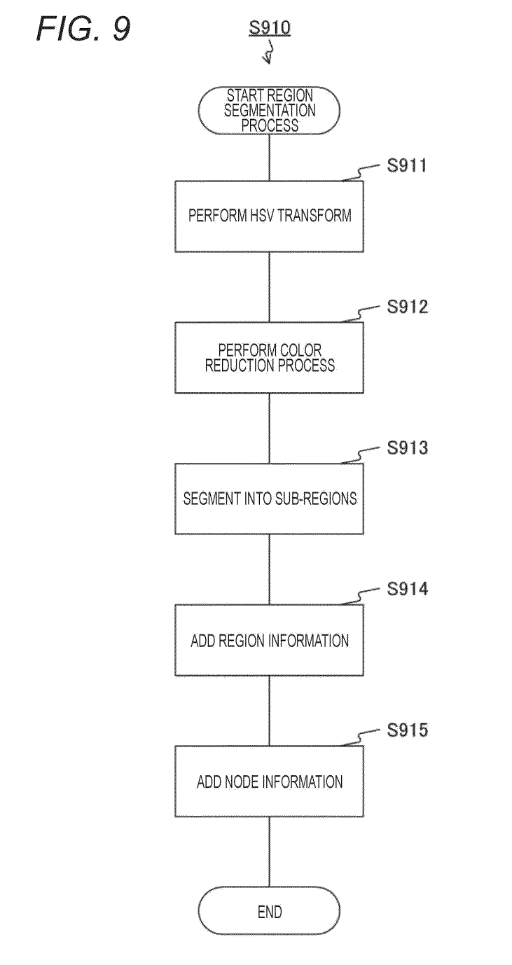

FIG. 9 is a flowchart illustrating an example of a region segmentation process according to the first embodiment of the present technology. The coding unit 200 performs HSV transform on the input frame (step S911) and performs the color reduction process (step S912). The coding unit 200 segments the input frame having been subjected to the HSV transform process and the color reduction process into a plurality of sub-regions having different feature amounts (step S913). The coding unit 200 generates region information of the respective sub-regions to add the region information to the input frame (step S914) and generates node information of respective nodes to further add the node information to the input frame (step S915). After step S915, the coding unit 200 ends the region segmentation process.

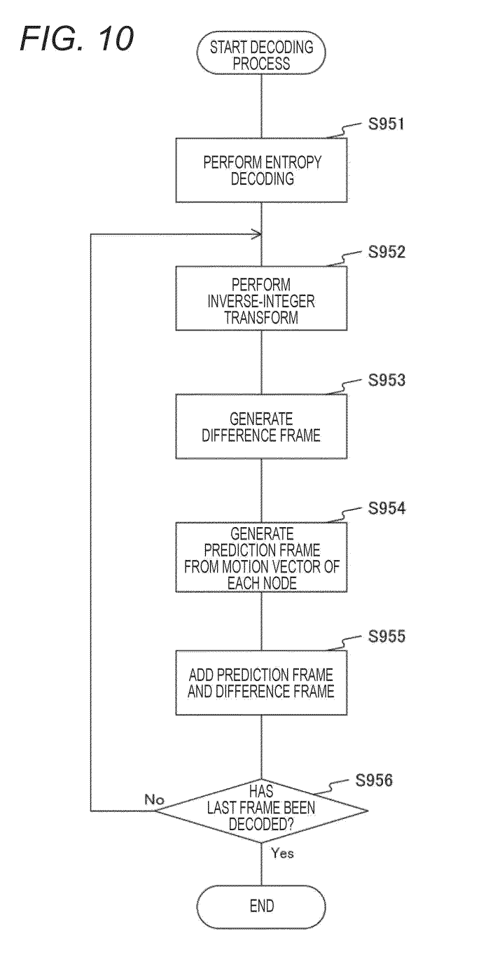

FIG. 10 is a flowchart illustrating an example of a decoding process according to the first embodiment of the present technology. This decoding process starts when coding data is supplied to the decoding unit 300, for example. The decoding unit 300 decodes the coding data according to a decoding algorithm corresponding to the entropy coding algorithm (step S951). The decoding unit 300 performs reverse-integer transform on the transform coefficient to generate a plurality of sub-regions (step S952) and combines these sub-regions to generate a difference frame (step S953). Moreover, the decoding unit 300 generates a prediction frame from the reference frame and the node motion vector of each node (step S954). Moreover, the decoding unit 300 adds the prediction frame and the difference frame to decode the non-reference frame (step S955). The decoding unit 300 determines whether the last input frame has been decoded (step S956). The decoding unit 300 ends the decoding process when the last input frame has been decoded (Yes in step S956) and returns to step S952 if not (No in step S956).

As described above, according to the first embodiment of the present technology, since the imaging apparatus 100 segments a frame into a plurality of sub-regions having different feature amounts and detects a motion vector of each node on these boundary lines, it is possible to code moving pictures without segmenting the frame into blocks. Due to this, it is possible to prevent block noise and improve the quality of moving pictures.

### [Modifications]

In the first embodiment, although the imaging apparatus 100 is configured to decode coding data, an external device of the imaging apparatus 100 may decode the coding data. A picture processing system according to a modification is different from the first embodiment in that an external device of the imaging apparatus 100 decodes the coding data.

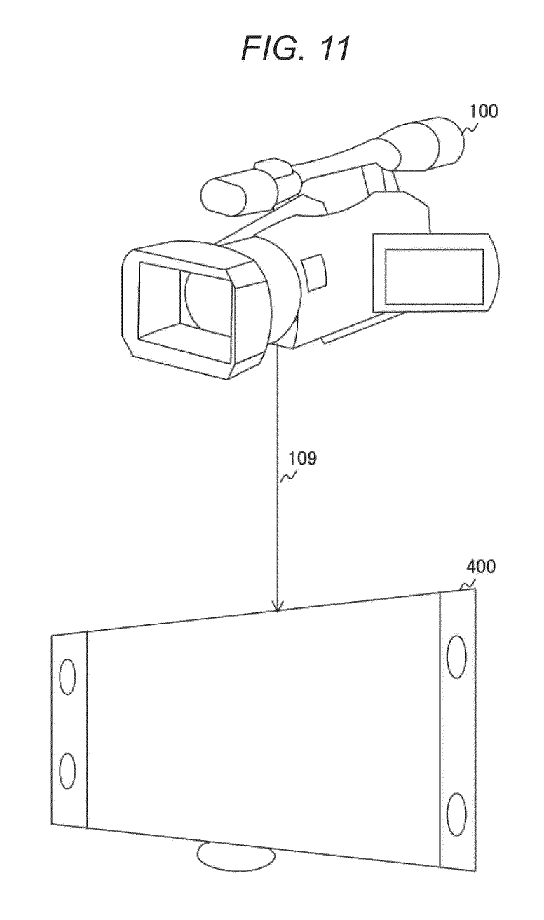

FIG. 11 is a perspective view illustrating an example of a picture processing system according to a modification of the present technology. This picture processing system includes an imaging apparatus 100 and a display device 400. The imaging apparatus 100 of the modification of the present technology has the same configuration as that of the first embodiment. The imaging apparatus 100 supplies coding data to the display device 400 via a signal line 109. For example, a HDMI (the registered trademark) cable is used as the signal line 109.

The HDMI (the registered trademark) cable has a transfer rate as high as 3 Gbps (Giga bit per second) at highest and can easily transfer coding data of which the data amount is reduced by compression.

The display device 400 is configured to decode the coding data into original moving picture data and display frames in the moving picture data in a time-series order.

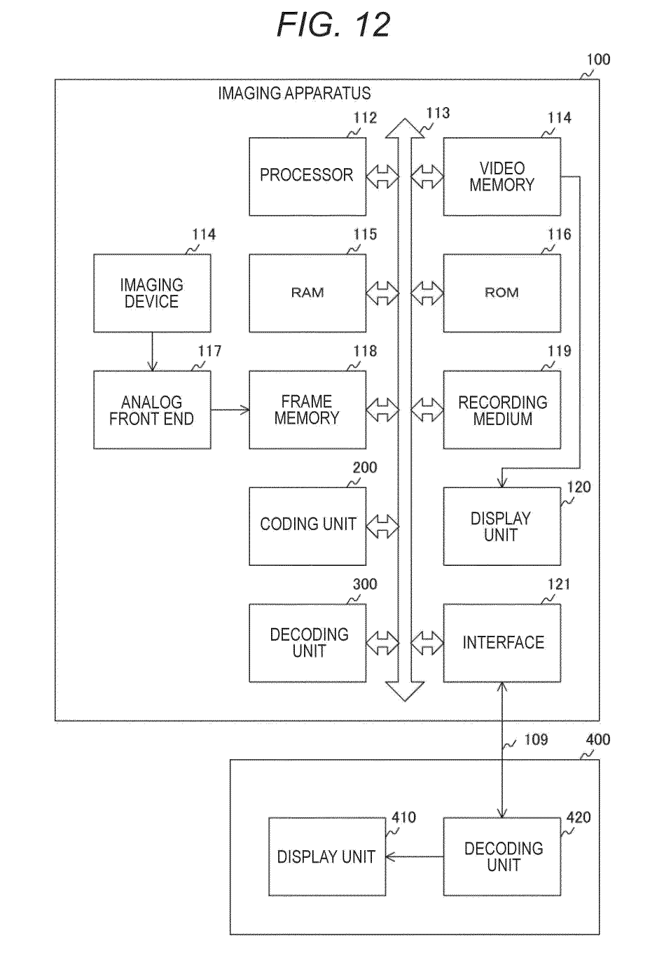

FIG. 12 is a block diagram illustrating an example of the picture processing system according to the modification of the present technology. The display device 400 includes a display unit 410 and a decoding unit 420. The decoding unit 420 has the same configuration as the decoding unit 300 of the imaging apparatus 100. The decoding unit 420 acquires coding data from the imaging apparatus 100, decodes the coding data into original moving picture data, and supplies the moving picture data to the display unit 410. The display unit 410 is configured to display the input frames in the moving picture data in a time-series order.

When transmitting and receiving coding data, the imaging apparatus 100 transmits a request for asking about a coding method that the display device 400 can decode and the display device 400 sends a response in response to the request. When the display device 400 can decode the coding data, the imaging apparatus 100 transmits the coding data. The transmission method may be a packetized elementary stream (PES) transmission method in which data is transmitted in respective packet units and may be a progressive transmission method in which data is reproduced while being transmitted.

Although the imaging apparatus 100 transmits the coding data to the display device 400, decoded moving picture data may be transmitted when the signal line 109 has a sufficiently high transfer rate. In this case, the imaging apparatus 100 transmits a request for asking about the screen size or the like of the display device 400 and the display device 400 sends a response in response to the request. The imaging apparatus 100 decodes the coding data into moving picture data based on the response and transmits the moving picture data to the display device 400.

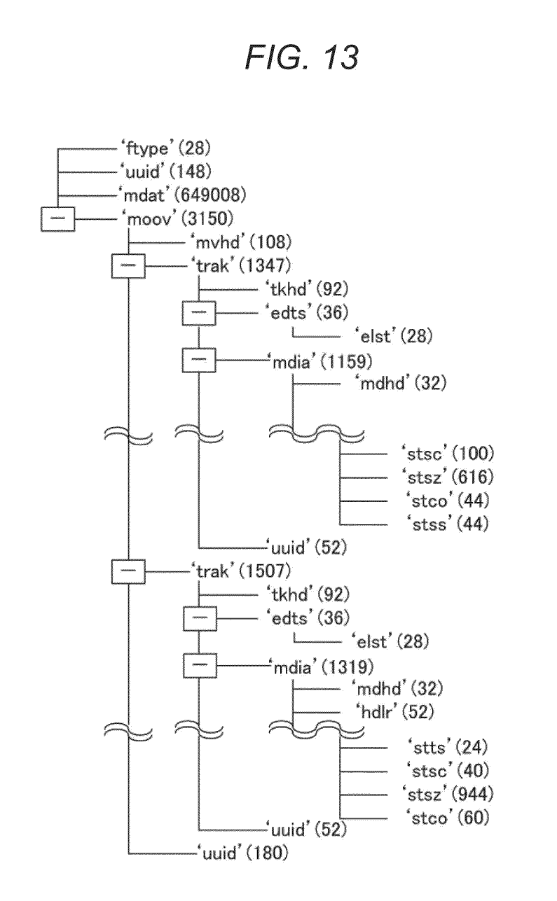

FIG. 13 is a diagram illustrating an example of data configuration of the header of a file including coding data according to the modification of the present technology. As illustrated in FIG. 13, information such as “ftyp” is described in the header.

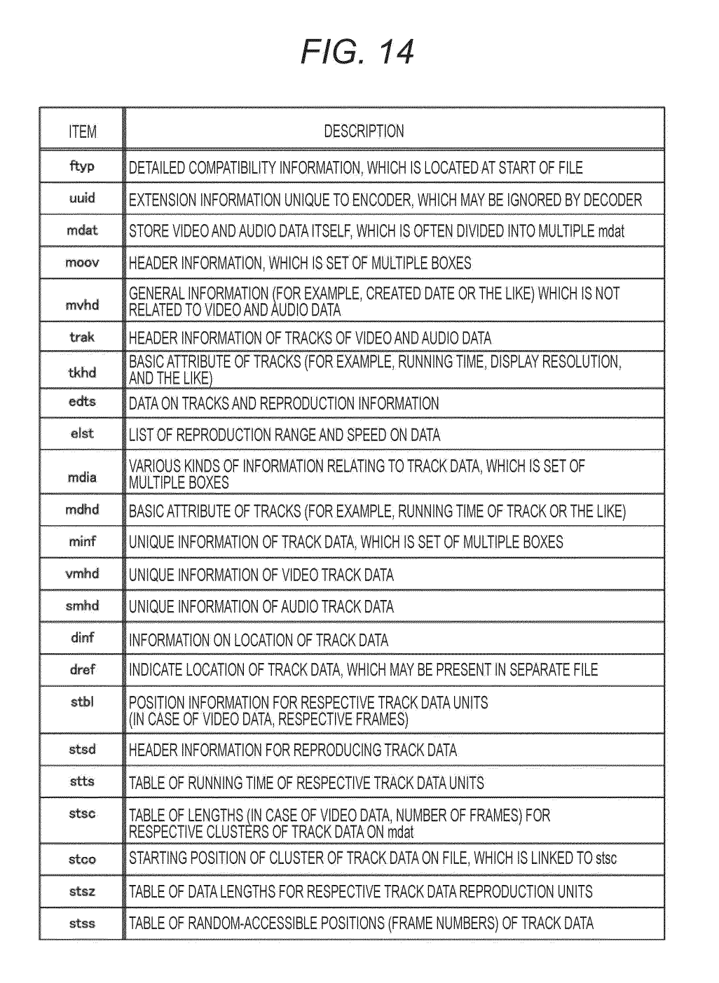

FIG. 14 is a diagram illustrating an example of items and descriptions of the header of a file including coding data according to the modification of the present technology. As illustrated in FIG. 14, information on compatibility is described in “ftyp”.

Although a compression format of coding data is different from that of MPEG (Moving Picture Experts Group) format, the header portion of the file format can be defined based on the MPEG format. As illustrated in FIGS. 13 and 14, the imaging apparatus 100 describes codes for identifying coding data in “ftype” of the header using the header of the MPEG format. In this way, it is possible to inhibit reproduction of coding data on other types of decoders and to allow files to be smoothly loaded into a decoder conforming to the standard of the coding data. Moreover, some of the video players of recent years read the “ftype” portion to automatically recognize the decoding format and then decode files and reproduce moving pictures. Thus, it is possible to improve the convenience of video players.

As described above, according to the modification of the first embodiment, since the imaging apparatus 100 transmits coding data without decoding the same and the display device 400 decodes the coding data, it is possible to reduce the amount of data transmitted between both apparatuses as compared to a configuration in which coding data is transmitted after being decoded.

### 2. Second Embodiment

### [Configuration Example of Imaging Apparatus]

In the first embodiment, although the imaging apparatus 100 outputs decoded frames without magnifying the same, the imaging apparatus 100 may output the frames after magnification (so-called up-converting) the same. In today's high-vision digital TV broadcasting, although moving pictures of the normal resolutions of 1080i, 720p, and 1080p are broadcast, moving pictures having the resolutions of 2160p and 4320p called 4K and 8K will be broadcast in the future. Moreover, 80-inch 4K TVs are sold in recent years, and there are certain needs for up-converting techniques in the existing high-vision broadcasting. The imaging apparatus 100 of the second embodiment is different from the first embodiment in that decoded frames are magnified.

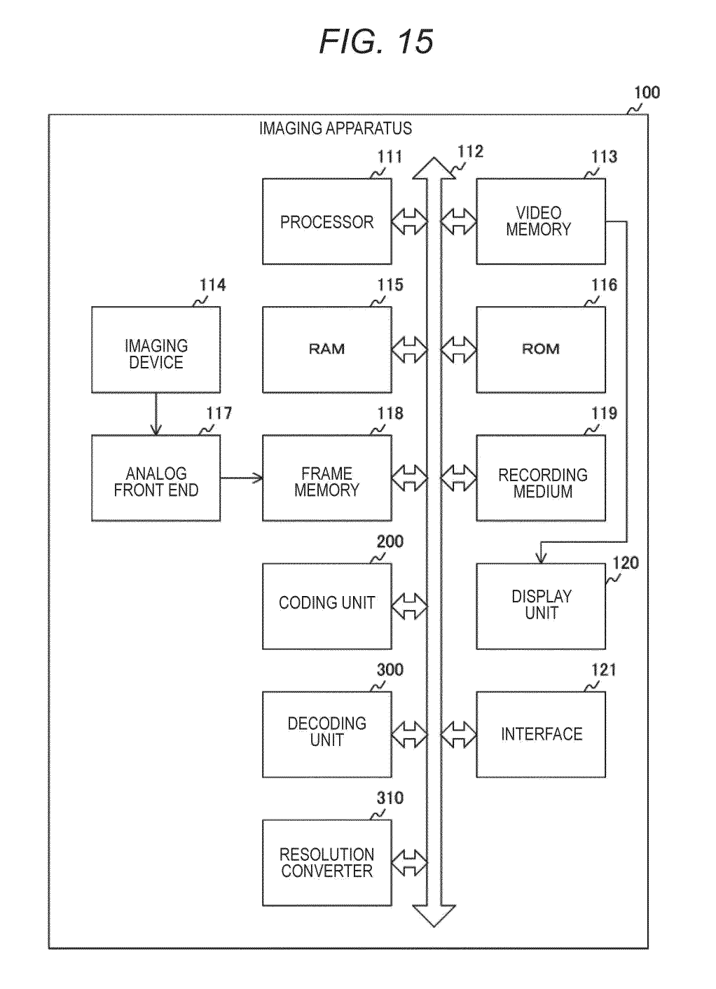

FIG. 15 is a block diagram illustrating a configuration example of an imaging apparatus 100 according to the second embodiment of the present technology. This imaging apparatus 100 is different from the first embodiment in that the imaging apparatus 100 further includes a resolution converter 310.

The resolution converter 310 is configured to magnify a portion of an input frame in decoded moving picture data by converting the resolution. It is assumed that the region information and the node information are added to the input frame by the decoding unit 300. The resolution converter 310 supplies the magnified frame to the video memory 113, the recording medium 119, or the interface 121.

### [Configuration Example of Resolution Converter]

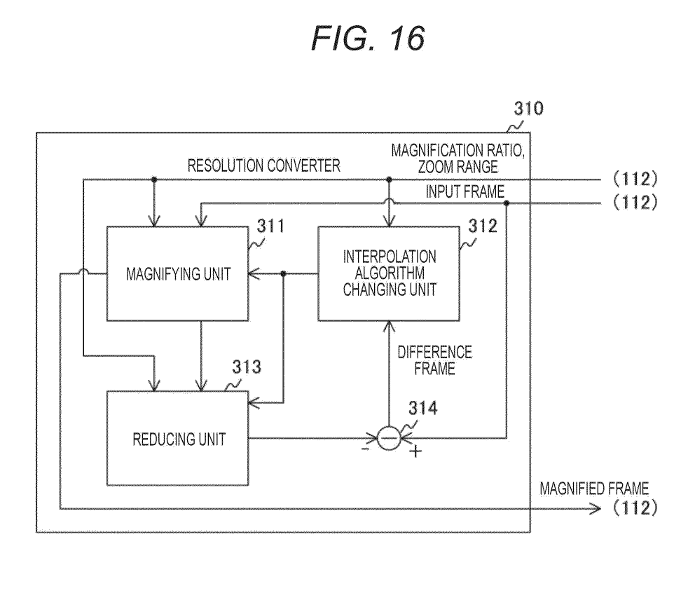

FIG. 16 is a block diagram illustrating a configuration example of the resolution converter 310 according to the second embodiment of the present technology. The resolution converter 310 includes a magnifying unit 311, an interpolation algorithm changing unit 312, a reducing unit 313, and a subtractor 314.

The magnifying unit 311 is configured to magnify a portion of the decoded input frame. A magnification ratio and a zoom range are set in the magnifying unit 311. Here, the zoom range indicates a range of a target region to be magnified, of the input frame. The zoom range is set according to a user's operation, for example. Moreover, the magnification ratio is set as a proportion of the size of the zoom range to the size of an input frame before magnifying, for example. The magnifying unit 311 acquires an input frame from the bus 112 and magnifies the zoom range in the input frame. During the magnifying, the magnifying unit 311 changes the positions of the respective nodes in the zoom range according to the magnification ratio. Specifically, if the node coordinate is (x, y) and the magnification ratio is r (r is a real number), the magnifying unit 311 changes the position of the node to the coordinate (r×x,r×y). Moreover, the magnifying unit 311 interpolates the changed nodes with segments according to an interpolation algorithm based on the region information and the node information and sets color information of an original sub-region corresponding to a new sub-region surrounded by the segments in the new sub-region. Here, the magnifying unit 311 stores a plurality of interpolation algorithms (a linear interpolation algorithm, a Bezier interpolation algorithm, a spline interpolation algorithm, and the like) and uses an optional algorithm among these algorithms. The magnifying unit 311 supplies the frame in which the zoom range is magnified to the reducing unit 313 as a magnified frame.

The reducing unit 313 is configured to reduce the magnified frame. The reducing unit 313 receives the magnification ratio and the magnified frame and reduces the magnified frame using the reciprocal of the magnification ratio as a reduction ratio. During the reducing, the reducing unit 313 changes the positions of the respective nodes in the magnified frame according to the reduction ratio. Moreover, the reducing unit 313 interpolates the changed nodes with segments according to an interpolation algorithm based on the region information and the node information and sets color information of an original sub-region corresponding to a new sub-region surrounded by the segments in the new sub-region. Here, the reducing unit 313 uses the same interpolation algorithm as used in the magnifying unit 311. The reducing unit 313 supplies the reduced frame to the subtractor 314 as a reduction frame.

The subtractor 314 is configured to calculate a difference between the input frame and the reduction frame corresponding to the input frame. The subtractor 314 calculates a difference between the pixel value of each pixel in the input frame and the pixel value of each pixel in the frame corresponding to the pixel and supplies a frame made up of these differences to the integer transform unit 203 as a difference frame. The difference frame includes an interpolation error of the interpolation.

The interpolation algorithm changing unit 312 is configured to change an interpolation algorithm based on the interpolation error. The interpolation algorithm changing unit 312 acquires a statistic amount (for example, the mean) of the pixel values in the zoom range of the difference frame as the interpolation error. Moreover, the interpolation algorithm changing unit 312 changes the interpolation algorithm to be used in the magnifying unit 311 and the reducing unit 313 according to the interpolation error. For example, if the interpolation error is larger than an allowable value, the interpolation algorithm changing unit 312 changes the interpolation algorithm to an interpolation algorithm having higher accuracy. If the interpolation error obtained with an interpolation algorithm having highest interpolation accuracy is not smaller than the allowable value, the interpolation algorithm changing unit 312 sends a notification to end the conversion process to the magnifying unit 311.

When the interpolation algorithm changing unit 312 does not change the interpolation algorithm or sends a notification to end the conversion process, the magnifying unit 311 outputs the magnified frame to the bus 112. When the interpolation algorithm is changed, the magnifying unit 311 magnifies the zoom range again using the changed interpolation algorithm and supplies the magnified frame to the reducing unit 313.

Although the magnifying unit 311 magnifies a portion (the zoom range) of the input frame, the magnifying unit 311 may magnify the entire input frame.

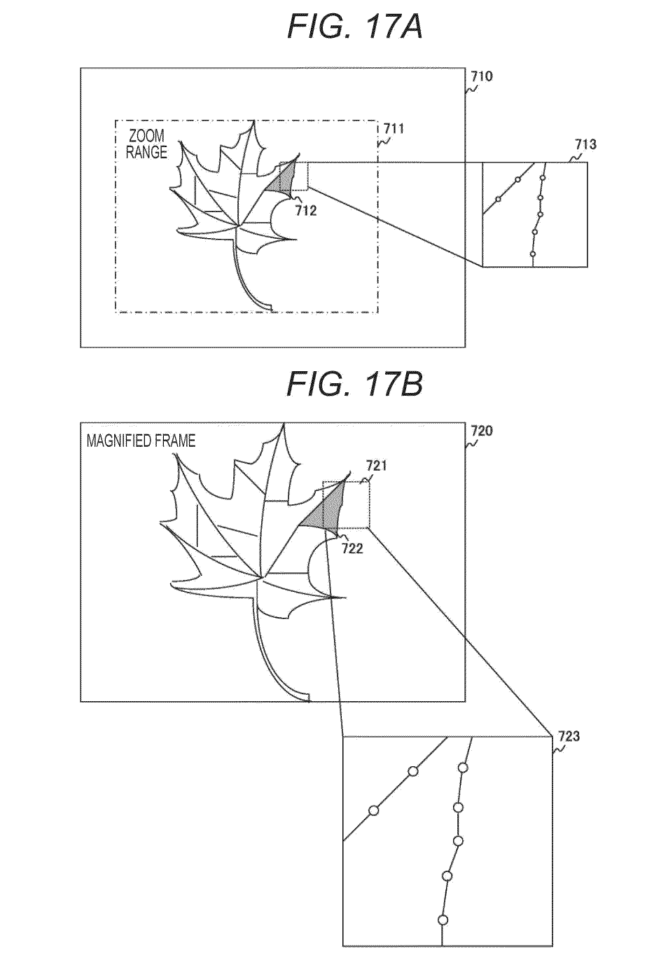

FIGS. 17A and 17B are diagrams illustrating an example of a frame before and after magnification according to the second embodiment of the present technology. FIG. 17A illustrates an example of an input frame before magnifying. In the input frame 710, a zoom range 711 is designated by a user or the like. The zoom range 711 includes a sub-region such as a sub-region 712, and a plurality of nodes is provided on the boundary lines of the sub-region as illustrated in a rectangular region 713 which is an enlarged view of a portion of the sub-region 712. The imaging apparatus 100 changes the positions of the respective nodes according to the magnification ratio. FIG. 17B illustrates an example of a magnified frame 720 after magnification. The magnified frame 720 includes a sub-region such as a sub-region 722 corresponding to the sub-region 712, and a plurality of nodes is provided on the boundary lines of the sub-region as illustrated in a rectangular region 723 which is an enlarged view of a portion of the sub-region 722.

When a frame is magnified without using the region information and the node information, an algorithm of interpolating a number of new pixels corresponding to the resolution between the neighboring pixels is used. In such a magnification algorithm, the larger the magnification ratio is, the higher the possibility of the outline of a subject to blur becomes. If a low-pass filter or the like is used to make the outline smooth, the outline becomes unclear. Thus, in the image processing apparatus of the related art, it is necessary to enhance edges using a luminance transient improver circuit or the like that enhances and corrects the outline of a luminance signal.

In contrast, as illustrated in FIGS. 17A and 17B, according to the imaging apparatus 100 that changes the node positions according to the magnification ratio and interpolating these nodes, it is possible to clearly draw the outline while increasing the magnification ratio without using the luminance transient improver circuit or the like.

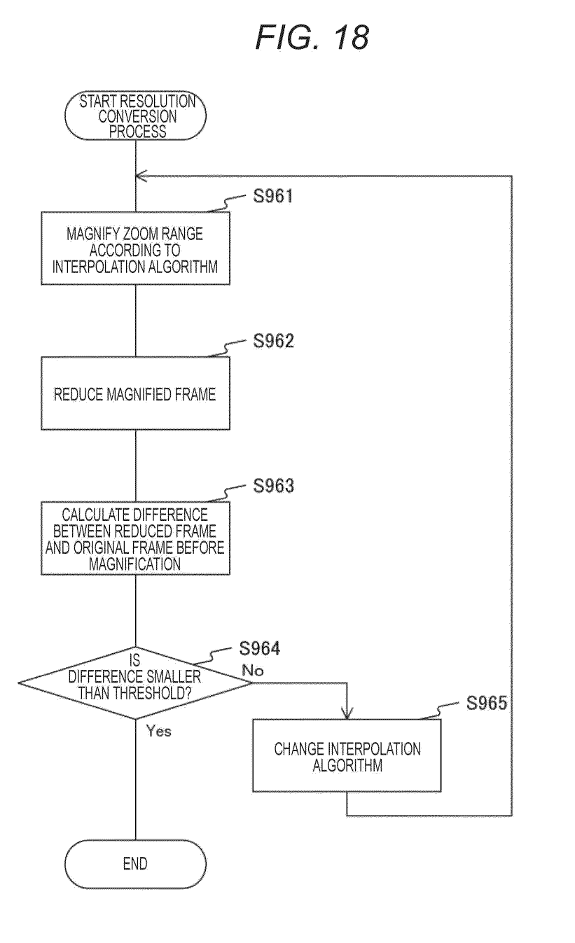

FIG. 18 is a flowchart illustrating an example of a resolution conversion process according to the second embodiment of the present technology. This resolution conversion process starts when an input frame is input to the resolution converter 310, for example. The resolution converter 310 magnifies the zoom range using an interpolation algorithm to generate a magnified frame (step S961) and reduces the magnified frame (step S962).

Moreover, the resolution converter 310 calculates a difference between the reduction frame and the original input frame (step S963) and determines whether the difference is smaller than a threshold (step S964). When the difference is not smaller than the threshold (No in step S964), the resolution converter 310 changes the interpolation algorithm (step S965) and returns to step S961. When the difference is smaller than the threshold (Yes in step S964), the resolution converter 310 outputs the magnified frame and ends the resolution conversion process.

As described above, according to the second embodiment of the present technology, since the imaging apparatus 100 changes the positions of the plurality of nodes according to the magnification ratio and generates a magnified frame from regions of which the boundary lines are formed by lines on which the nodes are provided, it is possible to clearly draw the boundary lines. Due to this, it is possible to improve the quality of the magnified frame.

### 3. Third Embodiment

[Configuration Example of Region Combining Unit]

In the first embodiment, although the imaging apparatus 100 does not detect an object in respective frames, a group of sub-regions in which the motion vectors are the same may be detected as one object. The imaging apparatus 100 according to the third embodiment is different from that of the first embodiment in that the imaging apparatus 100 detects an object.

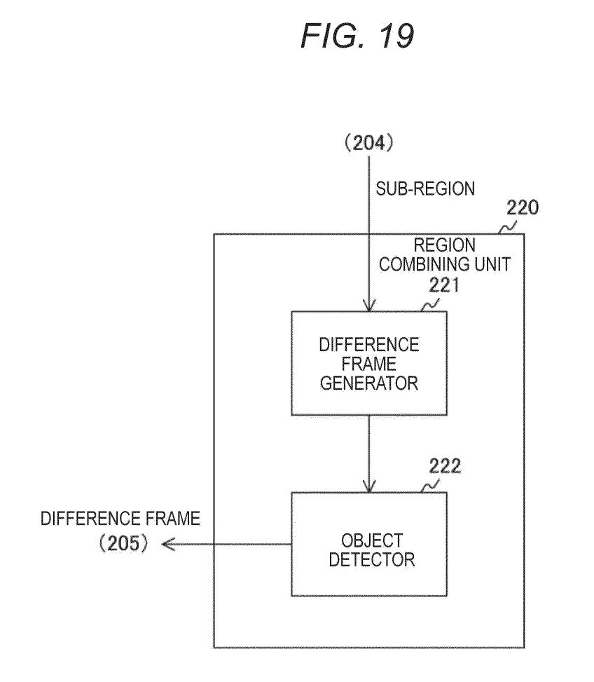

FIG. 19 is a block diagram illustrating a configuration example of a region combining unit 220 according to the third embodiment of the present technology. The region combining unit 220 includes a difference frame generator 221 and an object detector 222.

The difference frame generator 221 is configured to combine sub-regions to generate a difference frame. The difference frame generator 221 supplies the generated difference frame to the object detector 222.

The object detector 222 is configured to merge neighboring sub-regions having the same region motion vector and detect the merged region as the region of an object (hereinafter, this region will be referred to as an “object region”). Here, the region motion vector is a vector of which both ends are the reference coordinates of the corresponding sub-region pair and is calculated by the motion vector detector 208 for the respective sub-regions. The object detector 222 repeatedly performs the process of merging neighboring sub-regions having the same region motion vector in the respective input frames until there is no combinable sub-region. Moreover, the object detector 222 detects the respective merged regions as object regions. The object detector 222 correlates the respective sub-regions in the object region and assigns an object ID unique in the input frame to the object region.

Moreover, the object detector 222 sets a reference coordinate (for example, the central coordinate) of the object region and substitutes the respective reference coordinates of the sub-regions in the object region with relative coordinates about the reference coordinate of the object region. The object detector 222 generates object information including the object ID and the reference coordinate of the object region, further adds the object information to the difference frame, and supplies the difference frame to the adder 205.

The motion vector detector 208 of the second embodiment further calculates an object type and an object motion vector of each object based on the region motion vector. The same value as the region motion vector in the object region is set to the object motion vector. Moreover, information indicating the type of an object is set to the object type. For example, if an object has an object motion vector of which the length is larger than a threshold, “moving object” is set to the object type.

When object regions having a region motion vector of which the length is equal to or smaller than the threshold include a corresponding object region in the reference frame and the non-reference frame, “background” is set to the object region and “the other” is set if not. For example, when noise occurs in a region or the background has changed between frames, since the corresponding object region is not present, “the other” is set to the region.

Here, in the first embodiment, for sub-regions of which the boundary shape is greatly distorted between frames, since the feature amount deviates, it may be difficult to extract the corresponding sub-regions. Thus, the motion vector detector 208 of the second embodiment can improve the accuracy of extracting corresponding sub-regions using the region motion vector.

For example, the motion vector detector 208 extracts sub-regions having the same motion vector by performing clustering using the K-means method and extracts a specific sub-region from the assumption that a positional relation between neighboring frames does not change greatly. Specifically, the motion vector detector 208 correlates the respective sub-regions based on the SSD or the SAD and clusters the sub-regions according to the K-means algorithm using the mean of the region motion vectors of the sub-regions. During the clustering, the motion vector detector 208 detects whether regions in a set of neighboring sub-regions belongs to different clusters. Moreover, when the number of sets of sub-regions belonging to different clusters is larger than a predetermined number, the motion vector detector 208 re-extracts sub-regions belonging to the same cluster preferentially.

Even when sub-regions are clustered based on the mean of the region motion vectors, sub-regions that may not be correlated may occur. In this case, the motion vector detector 208 negates the reference destination region IDs of such sub-regions. For example, when a camera images a subject while rotating around the subject three-dimensionally like revolve-tracking, a sub-region present at the start of imaging may hide behind a subject or a new sub-region may appear in front of a subject as the camera moves around the subject. In this case, the motion vector detector 208 may negate the reference destination region ID of the sub-region and may track back from that point of time.

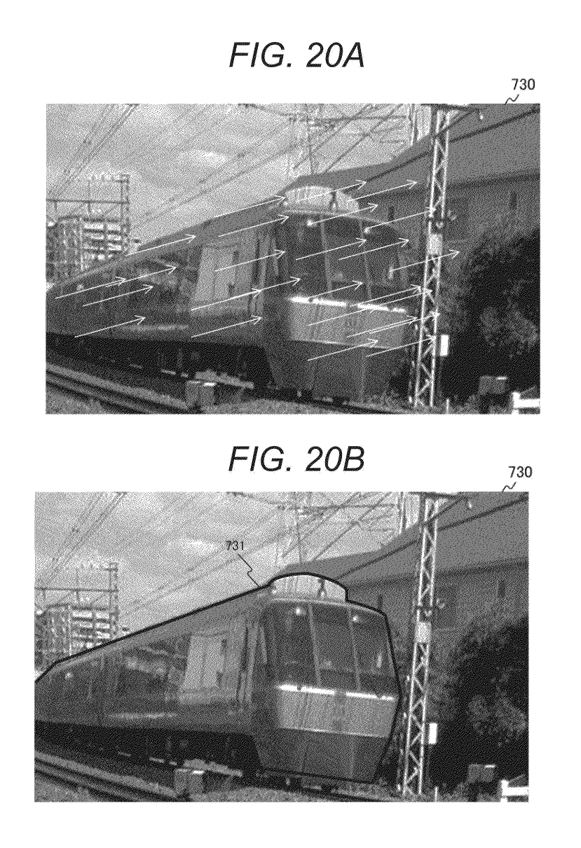

FIGS. 20A and 20B are diagrams illustrating an example of a frame in which a moving object is detected according to the third embodiment of the present technology. FIG. 20A illustrates an example of an input frame 730 in which region motion vectors of respective sub-regions are detected. In FIG. 20A, white arrows indicate region motion vectors. As illustrated in FIG. 20A, the region motion vectors of respective sub-regions in the same object (a subway in FIG. 20A) are the same.

FIG. 20B illustrates an example of an input frame 730 in which an object is detected. The imaging apparatus 100 merges neighboring sub-regions having the same region motion vector and detects the merged region as an object region 731. Although a frame in which an object region is detected is actually a difference frame, in the figure, an input frame corresponding to the difference frame is illustrated for the sake of convenience.

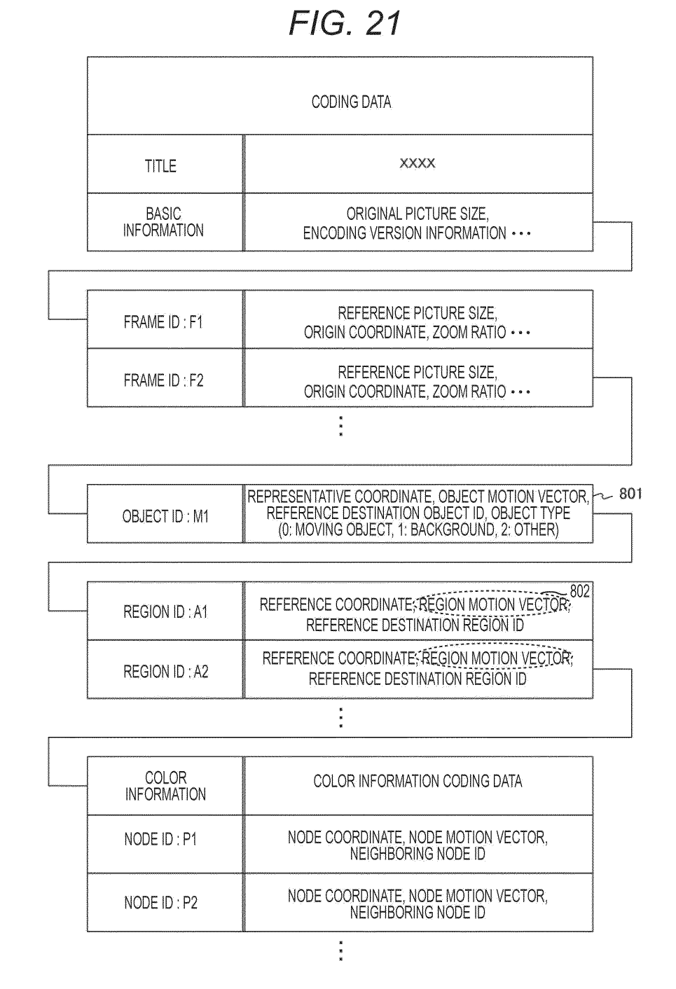

FIG. 21 is a diagram illustrating an example of a data structure of coding data according to the third embodiment of the present technology. In the coding data according to the third embodiment, object information 801 is correlated with the frame information. The object information 801 includes an object ID, a reference coordinate, an object motion vector, a destination object ID, and an object type. Here, the destination object ID of the non-reference frame is an object ID of a corresponding object region of the reference frame. On the other hand, in the reference frame, an invalid value is set to the destination object ID.

The object ID and the reference coordinate of the object information are generated by the object detector 222.

Moreover, the object motion vector, the object type, and the destination object ID are generated by the motion vector detector 208.

Moreover, region information of the respective sub-regions in an object region indicated by the object information is stored in the object information. The region information according to the third embodiment further includes a region motion vector. The region motion vector is generated by the motion vector detector 208.

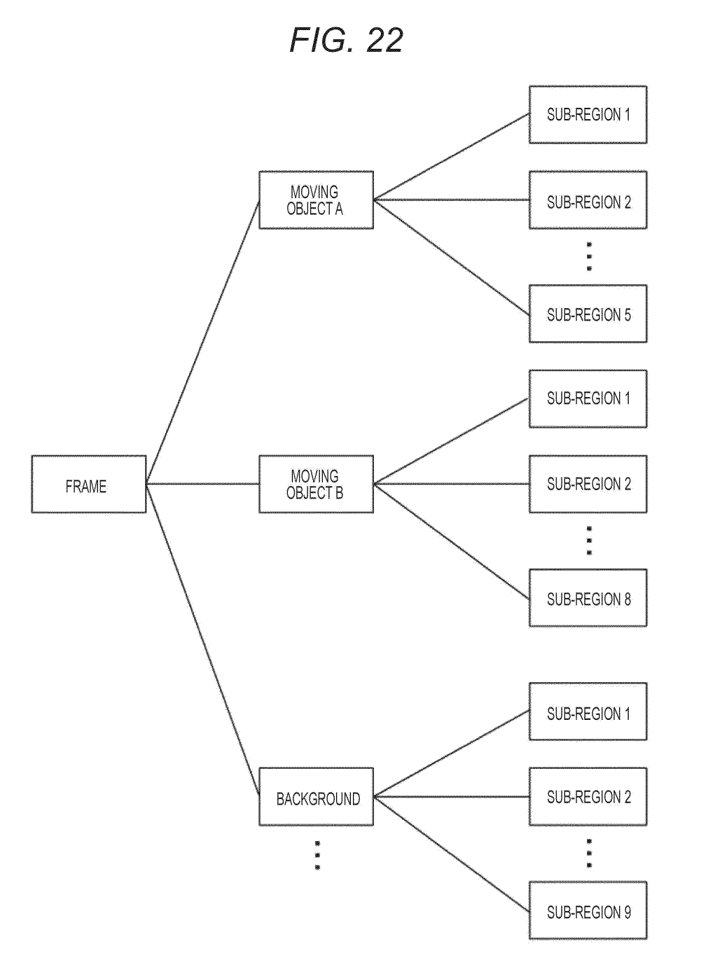

FIG. 22 is a diagram illustrating an example of a hierarchical structure of an input frame according to the third embodiment of the present technology. As illustrated in FIG. 22, the object regions of a moving object and the background are correlated with the input frame. Moreover, the respective sub-regions in the object region are correlated with the object region.

### [Configuration Example of Picture Processing Apparatus]

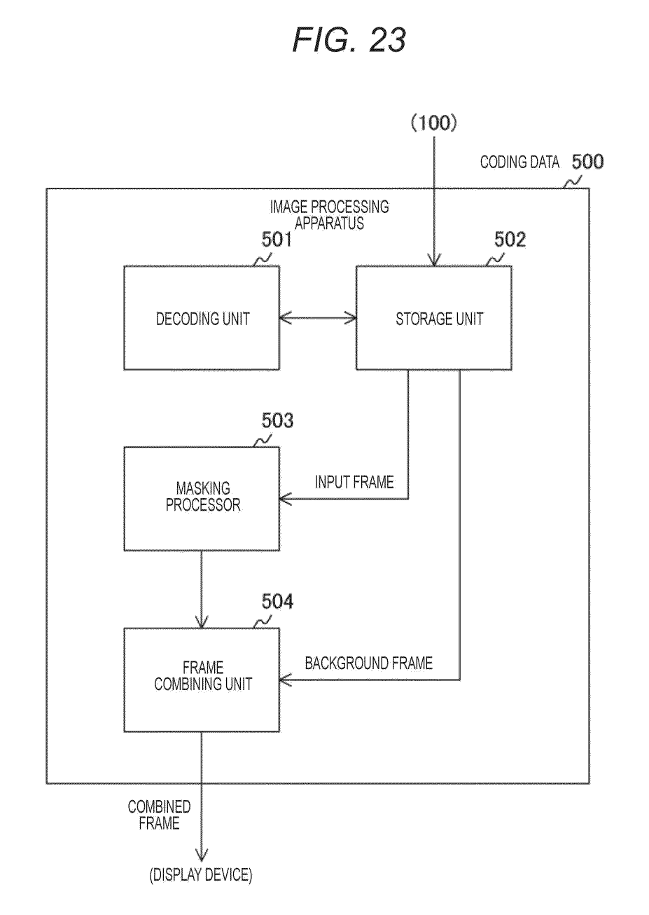

FIG. 23 is a block diagram illustrating a configuration example of an image processing apparatus 500 according to the third embodiment of the present technology. The image processing apparatus 500 is configured to acquire coding data from the imaging apparatus 100, decodes the coding data, and performs a predetermined image processing on the decoded data. The image processing apparatus 500 includes a decoding unit 501, a storage unit 502, a masking processor 503, and a frame combining unit 504.

The decoding unit 501 has the same configuration as the decoding unit 300 of the first embodiment. The decoding unit 501 reads and decodes coding data from the storage unit 502, decodes the coding data to generate moving picture data, and supplies the moving picture data to the storage unit 502. The storage unit 502 is configured to store coding data, moving picture data, and a background frame. Here, the background frame is a frame to be combined with the input frame and is stored in advance in the storage unit 502.

The masking processor 503 is configured to mask an object region in an input frame, designated by a user's operation or the like. For example, a moving object is designated as an object to be masked. The masking processor 503 calculates a masking region based on the region information and the node information added to the input frame, generates a frame in which the region is masked, and supplies the frame to the frame combining unit 504.

The frame combining unit 504 is configured to combine a masked frame with the background frame. An alpha value indicating a combination ratio is set in the frame combining unit 504. The frame combining unit 504 performs frame combination based on the combination ratio. Such a frame combination process is referred to as alpha blending. The frame combining unit 504 outputs the combined frame to an external display device or the like as a combination frame.

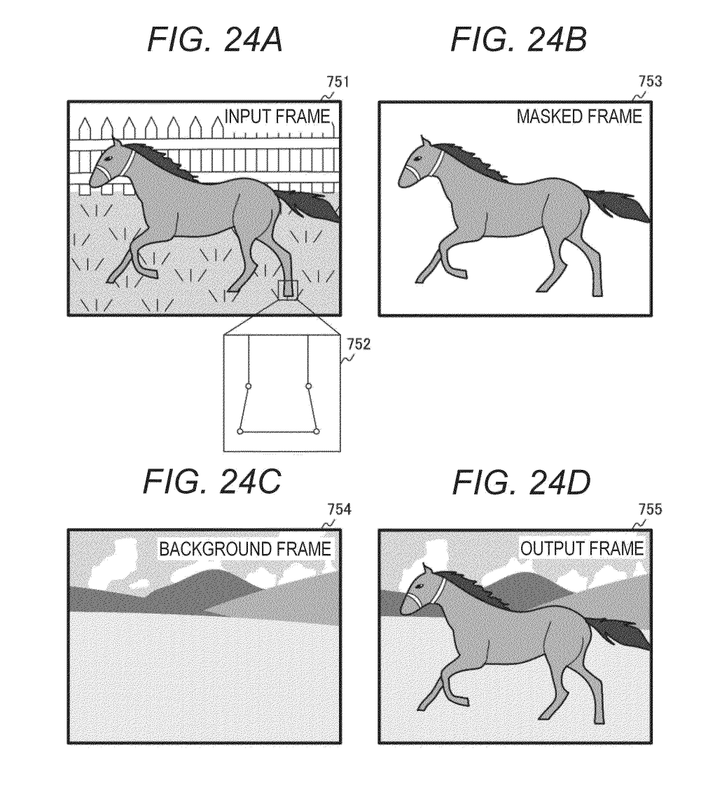

FIGS. 24A to 24D are diagrams illustrating an example of a frame before and after frame combination according to the third embodiment of the present technology. FIG. 24A illustrates an example of an input frame. Object information, node information, and the like are added to the input frame. Solid lines in a rectangular region 752 which is an enlarged view of a portion of the input frame 751 indicate boundary lines of an object indicated by the object information and the node information. Moreover, white circles in the rectangular region 752 indicate nodes indicated by the node information.

FIG. 24B illustrates an example of a masked frame 753. In this frame 753, a horse is designated as a masking object by a user or the like, and the image processing apparatus 500 masks the horse region based on the object information and the node information.

FIG. 24C illustrates an example of a background frame 754 to be combined. FIG. 24D illustrates an example of a combination frame 755 obtained by combining the background frame 754 and the masked frame 753. As illustrated in FIG. 24D, the combination frame 755 in which the horse region in the input frame 751 is combined with the background frame 754 is generated.

However, currently, moving pictures are generally edited nonlinearly using a computer. In recent years, moving pictures can be edited on a personal computer using the After Effects (the registered trademark) or the like which is software of Adobe Systems and general consumers can use sufficient functions. In editing moving pictures in this way, an image processing apparatus of the related art that performs chroma-key combination which involves replacement of the background performs mask processing using blue background or green background as a key. Moreover, the image processing apparatus creates a movable mask from the masked frame based on alpha blending and displays the background in a masking portion so that the background can be replaced.

However, since it is not possible to remove the effects of a reflection light or the like when the blue background or the green background is used, a movable mask is often created manually by post production in cinematography to combine the background. In this manner, in the image processing apparatus of the related art which does not use the object information and the node information, it is difficult to automatically perform mask processing.

In contrast, the image processing apparatus 500 can easily detect a masking region as illustrated in FIGS. 24A to 24D using the object information and the node information added to the input frame. Due to this, it is not necessary to create a movable mask by chroma-key combination or manual operations, and it is possible to improve the quality of created moving pictures and to reduce production costs of moving pictures.

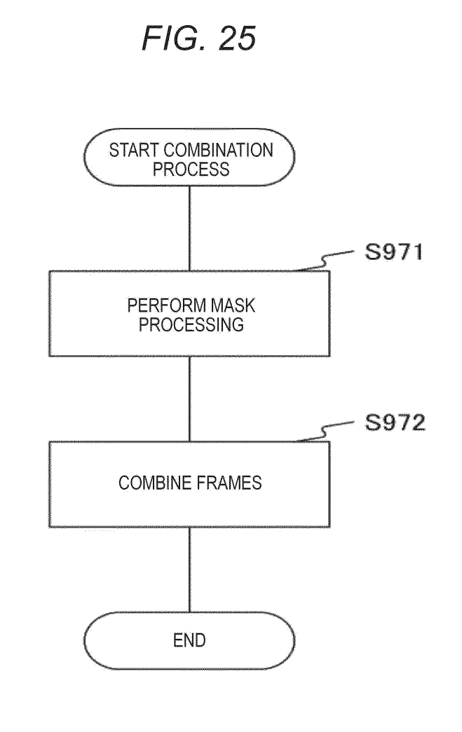

FIG. 25 is a flowchart illustrating an example of a frame combination process according to the third embodiment of the present technology. This frame combination process starts when an object to be masked is designated, for example. The image processing apparatus 500 executes mask processing of masking a designated object based on the object information and the node information (step S971) and combines the background frame with the masked frame (step S972). After step S972, the image processing apparatus 500 ends the frame combination process.

As described above, according to the third embodiment of the present technology, since the image processing apparatus 500 calculates the positions of the nodes of the non-reference frame from the nodes and the node motion vectors of the reference frame during the decoding, it is possible to acquire the accurate outline of an object to be masked from these nodes. Moreover, the image processing apparatus 500 masks the object and combines the masked frame with the combination target frame, it is possible to easily perform the frame combination process without a user's manual operations.

### 4. Fourth Embodiment

### [Configuration Example of Image Processing Apparatus]

In the third embodiment, although the image processing apparatus 500 performs the frame combination process in the input frame, the image processing apparatus 500 may perform an object recognition process instead of the frame combination process. The image processing apparatus 500 according to the fourth embodiment is different from that of the third embodiment in that the image processing apparatus 500 performs an object recognition process in the input frame.

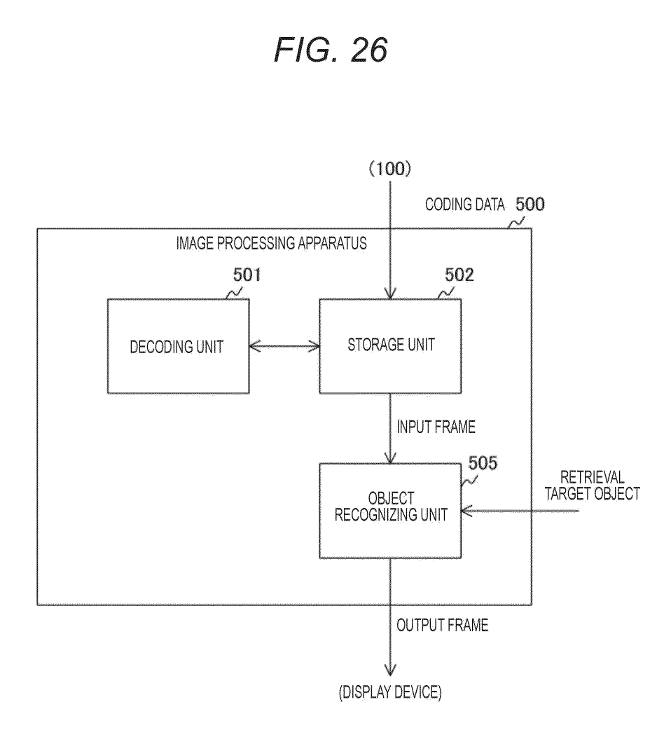

FIG. 26 is a block diagram illustrating a configuration example of the image processing apparatus 500 according to the fourth embodiment of the present technology. The image processing apparatus 500 is different from that of the third embodiment in that the image processing apparatus 500 includes an object recognizing unit 505 instead of the masking processor 503 and the frame combining unit 504.

The object recognizing unit 505 is configured to recognize an object designated by a user or the like in an input frame. A retrieval target object is input to the object recognizing unit 505. The image processing apparatus 500 has a touch panel (not illustrated) and displays an input frame on the touch panel when inputting an object. When a user designates an optional object in the displayed input frame by touch the object with a finger or the like, the picture data and the object information of the object are input to the object recognizing unit 505 as a retrieval target (that is, a recognition target). In this manner, an object region regarded as a recognition target of the object recognition is referred to as a region of interest (ROI). The object recognizing unit 505 acquires the feature amount and the object type of the input picture data and retrieves a retrieval target object in respective input frames in the moving picture data based on the feature amount and the object type. In this retrieval process, the object recognizing unit 505 recognizes objects having the same object type preferentially. Moreover, the object recognizing unit 505 recognizes object regions having high similarity of feature amounts preferentially. The object recognizing unit 505 performs a process of enhancing and displaying the boundary lines of the recognized object in the input frame in which an object is recognized and outputs the input frame to a display device or the like as an output frame.

As illustrated in the third embodiment, since the object information is added to the input frame of the decoded moving picture data, the object recognizing unit 505 can recognize objects having the same object type preferentially. Moreover, since the node information is added to the input frame, it is easy to extract the ROI. Due to this, it is possible to improve object recognition accuracy.

Although the picture data of a retrieval target object is input to the image processing apparatus 500 according to a user's operation, the picture data may be received from an external device of the image processing apparatus 500. For example, the functions of the image processing apparatus 500 may be mounted on a server connected to a network, and the server may receive the picture data of the retrieval target from a mobile communication terminal via the network. In general, an object recognition process is a heavy load process and it may be difficult to cope with the process with the information processing capability of a mobile communication device or the like. In such a case, a communication system in which a server performs the object recognition process is used.

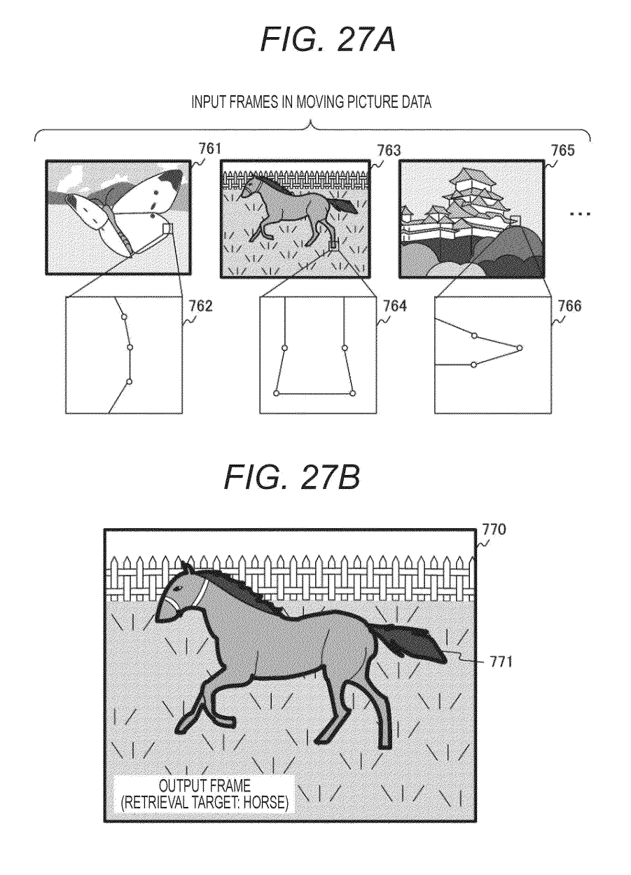

In such a communication system, a mobile terminal detects a retrieval target object region according to a user's operation based on the object information and the node information added to an input frame and transmits the picture data of the object to a server. Due to this, it is possible to a minimal amount of information necessary for object recognition to the network. Since the amount of information transmitted decreases, the picture data can be transmitted in such a period that no practical problem occurs in a communication line having a low communication speed. Moreover, since the information traffic also decreases, the network load also decreases. FIGS. 27A and 27B are diagrams for describing a retrieval process according to the fourth embodiment of the present technology. FIG. 27A illustrates an example of an input frame in moving picture data. The moving picture data includes input frames 761, 763, 765, and the like in which various moving objects and backgrounds are imaged. Object information and node information are added to these input frames. Solid lines in rectangular regions 762, 764, and 766 which are enlarged views of portions of the input frames 761, 763, and 765 indicate boundary lines of objects indicated by the object information and the node information. Moreover, white circles in the rectangular regions 762, 764, and 766 indicate nodes indicated by the node information.

FIG. 27B illustrates an example of an output frame 770 output as a retrieval result. When picture data of a horse as a retrieval target is input, the image processing apparatus 500 acquires the feature amount of the picture data and retrieves a retrieval target object in respective input frames based the feature amounts. In the input frame 763, the image processing apparatus 500 recognizes a retrieval target object region. The image processing apparatus 500 performs a process of enhancing and displaying the boundary lines of the recognized object and outputs the input frame as an output frame 770. In the output frame 770, an outline 771 is an enhanced portion.

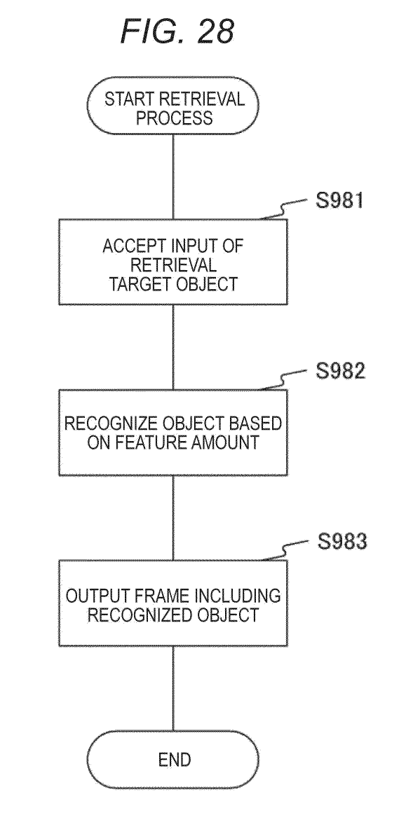

FIG. 28 is a flowchart illustrating an example of a retrieval process according to the fourth embodiment of the present technology. This retrieval process starts when an application for executing the retrieval process is executed in the image processing apparatus 500, for example. The image processing apparatus 500 accepts the input of a retrieval target object (step S981). When an object is input, the image processing apparatus 500 recognizes the object in respective input frames in the moving picture data based on the feature amount of the object (step S982). The image processing apparatus 500 outputs an input frame in which the object is recognized (step S983). After step S983, the image processing apparatus 500 ends the retrieval process.

As described above, according to the fourth embodiment of the present technology, since the image processing apparatus 500 calculates the positions of the nodes of the non-reference frame from the nodes and the node motion vectors of the reference frame during the decoding, it is possible to acquire the accurate outline of the retrieval target object from the nodes. Moreover, since the image processing apparatus 500 recognizes the retrieval target object in respective frames in the moving picture data, it is possible to easily extract a frame that includes the retrieval target object.

The embodiments of the present technology are shown as an example for implementing the present technology. As mentioned in the embodiments of the present technology, the matters in the embodiments of the present technology have corresponding relations to the present technology specifying matters in the claims. Similarly, the present technology specifying matters in the claims have corresponding relations to the matters in the embodiments of the present technology having the same names as the present technology specifying matters. However, the present technology is not limited to the embodiments, and various modifications can be made in the range without departing from the subject matter of the present technology.

In addition, the processing procedures described in the embodiments of the present technology may be grasped as the methods including the series of procedures. Moreover, the series of procedures may be grasped as the programs for making a computer execute the series of the procedures, or a recording medium storing the programs.

As the recording medium, a CD (compact disc), a MD (MiniDisc), a DVD (digital versatile disk), a memory card, a blu-ray disc (the registered trademark), and the like may be used.

The advantageous effects of the present technology are not necessarily limited to those described above but may include any advantageous effects described in the present technology.

The present technology may employ the following configurations.

(1) A coding apparatus including:
a region segmentation unit that segments each of a plurality of frames having different feature amounts in a coding target moving picture that includes the plurality of frames in a time-series order and provides a plurality of nodes on a boundary line of each of the sub-regions;
a motion vector detector that correlates each of the plurality of nodes on a reference frame serving as a reference among the plurality of frames with an optional node on a non-reference frame other than the reference frame and detects a vector of which both ends are at the correlated node pair as a node motion vector for respective node pairs; and
a coding data output unit that outputs data including the reference frame and the node motion vector as coding data obtained by coding the moving picture.
(2) The coding apparatus according to (1), further including:
a region merging unit that acquires a vector of which both ends are at a reference coordinate serving as a reference of the sub-region on the reference frame and a reference coordinate serving as a reference of the sub-region on the non-reference frame as a region motion vector in the respective sub-regions and merges the neighboring sub-regions having the same region motion vector, wherein
the coding data output unit outputs the coding data that further includes information indicating the merged sub-region as an object region.
(3) The coding apparatus according to (1) or (2), wherein
the region segmentation unit further generates node information indicating a relative coordinate about an optional coordinate in the sub-region for the respective nodes, and
the motion vector detector calculates the distance between the relative coordinate of the node on the reference frame and the relative coordinate of the node on the non-reference frame for the respective nodes and correlates the nodes at which the distance is the smallest.
(4)

The coding apparatus according to any of (1) to (3), further including:

a prediction frame generator that changes the positions of the plurality of nodes along the motion vector in the reference frame and generates a frame made up of new sub-regions of which the boundary lines are formed by lines on which the plurality of nodes of which the positions are changed is provided as a prediction frame obtained by predicting the non-reference frame; and
a difference detecting unit that detects a difference between pixel values of corresponding pixels in the prediction frame and the non-reference frame for respective pixels, wherein
the coding data output unit outputs the coding data that further includes the difference as a prediction error in prediction of the non-reference frame.
(5) A decoding apparatus including:
a reference frame acquiring unit that acquires a reference frame from the reference frame segmented into a plurality of sub-regions in which a plurality of nodes is provided on boundary lines and a plurality of node motion vectors of which one end is at an optional one of the plurality of nodes from coding data; and
a prediction frame generator that changes the positions of the plurality of nodes along the node motion vector in the reference frame and generates a frame made up of sub-regions of which the boundary lines are formed by lines on which the plurality of nodes of which the positions are changed is provided as a prediction frame obtained by predicting frames other than the non-reference frame.
(6) The decoding apparatus according to (5), further including:
a magnifying unit that changes the positions of the plurality of nodes in at least a portion of the reference frame and the prediction frame according to a set magnification ratio and generates a frame made up of new sub-regions of which the boundary lines are formed by lines on which the plurality of nodes of which the positions are changed is provided as a magnified frame.
(7) The decoding apparatus according to (5) or (6), further including:
a masking processor that performs mask processing to generate a frame in which the sub-region designated as a masking target in any one of the reference frame and the prediction frame is masked; and
a frame combining unit that combines a combination target frame with the masked frame.
(8) The decoding apparatus according to any of (5) to (7), further including:
an object recognizing unit that, when a feature amount of a recognition target object is designated, recognizes the recognition target object in the reference frame and the prediction frame based on the designated feature amount.
(9) Coding data that includes a reference frame segmented into a plurality of regions in which a plurality of nodes is provided on boundary lines and a plurality of node motion vectors of which one end is at an optional one of the plurality of nodes.
(10)

A coding method including:

allowing a region segmentation unit to segment each of a plurality of frames in a coding target moving picture that includes the plurality of frames in a time-series order into a plurality of sub-regions having different feature amounts and to provide a plurality of nodes on a boundary line of each of the sub-regions;
allowing a motion vector detector to correlate each of the plurality of nodes on a reference frame serving as a reference among the plurality of frames with an optional node on a non-reference frame other than the reference frame and to detect a vector of which both ends are at the correlated node pair as a node motion vector for respective node pairs; and
allowing a coding data output unit to output data including the reference frame and the node motion vector as coding data obtained by coding the moving picture.
(11)

A decoding method including:

allowing a coding data acquiring unit to acquire data including a reference frame segmented into a plurality of sub-regions in which a plurality of nodes is provided on boundary lines and a plurality of node motion vectors of which one end is at an optional one of the plurality of nodes as coding data;
allowing a prediction frame generator to change the positions of the plurality of nodes along the node motion vector in the reference frame and to generate a frame made up of sub-regions of which the boundary lines are formed by lines on which the plurality of nodes of which the positions are changed is provided as a prediction frame obtained by predicting frames other than the non-reference frame.
(12)

A program for causing a computer to execute:

allowing a region segmentation unit to segment each of a plurality of frames in a coding target moving picture that includes the plurality of frames in a time-series order into a plurality of sub-regions having different feature amounts and to provide a plurality of nodes on a boundary line of each of the sub-regions;

allowing a motion vector detector to correlate each of the plurality of nodes on a reference frame serving as a reference among the plurality of frames with an optional node on a non-reference frame other than the reference frame and to detect a vector of which both ends are at the correlated node pair as a node motion vector for respective node pairs; and

allowing a coding data output unit to output data including the reference frame and the node motion vector as coding data obtained by coding the moving picture.
(13)

A program for causing a computer to execute:

allowing a coding data acquiring unit to acquire data including a reference frame segmented into a plurality of sub-regions in which a plurality of nodes is provided on boundary lines and a plurality of node motion vectors of which one end is at an optional one of the plurality of nodes as coding data;
allowing a prediction frame generator to change the positions of the plurality of nodes along the node motion vector in the reference frame and to generate a frame made up of sub-regions of which the boundary lines are formed by lines on which the plurality of nodes of which the positions are changed is provided as a prediction frame obtained by predicting frames other than the non-reference frame.

### REFERENCE SIGNS LIST

100 Imaging apparatus
120 Display unit
121 Interface
200 Coding unit
201 Coding data output unit
202, 314 Subtractor
203 Integer transform unit
204, 303 Inverse-integer transform unit
205, 304 Adder
206, 302 Prediction frame generator
207 Frame buffer
208 Motion vector detector
209 Entropy coding unit
210 Region segmentation unit
211 HSV transform unit
212 Color reduction processor
213 Sub-region segmentation unit
214 Region information adding unit
215 Node information adding unit
220 Region combining unit
221 Difference frame generator
222 Object detector
300, 420, 501 Decoding unit
301 Entropy decoding unit
305 Region combining unit
310 Resolution converter
311 Magnifying unit
312 Interpolation algorithm changing unit
313 Reducing unit
400 Display device
410 Display unit
500 Picture processing apparatus
502 Storage unit
503 Masking processor
504 Frame combining unit
505 Object recognizing unit

What is claimed is:

1. A coding apparatus comprising:
a region segmentation unit that segments each of a plurality of frames having different feature amounts in a coding target moving picture that includes the plurality of frames in a time-series order and provides a plurality of nodes on a boundary line of each of the sub-regions;
a motion vector detector that correlates each of the plurality of nodes on a reference frame serving as a reference among the plurality of frames with an optional node on a non-reference frame other than the reference frame and detects a vector of which both ends are at the correlated node pair as a node motion vector for respective node pairs; and
a coding data output unit that outputs data including the reference frame and the node motion vector as coding data obtained by coding the moving picture.

2. The coding apparatus according to claim 1, further comprising:
a region merging unit that acquires a vector of which both ends are at a reference coordinate serving as a reference of the sub-region on the reference frame and a reference coordinate serving as a reference of the sub-region on the non-reference frame as a region motion vector in the respective sub-regions and merges the neighboring sub-regions having the same region motion vector, wherein
the coding data output unit outputs the coding data that further includes information indicating the merged sub-region as an object region.

3. The coding apparatus according to claim 1, wherein
the region segmentation unit further generates node information indicating a relative coordinate about an optional coordinate in the sub-region for the respective nodes, and
the motion vector detector calculates the distance between the relative coordinate of the node on the reference frame and the relative coordinate of the node on the non-reference frame for the respective nodes and correlates the nodes at which the distance is the smallest.

4. The coding apparatus according to claim 1, further comprising:
a prediction frame generator that changes the positions of the plurality of nodes along the motion vector in the reference frame and generates a frame made up of new sub-regions of which the boundary lines are formed by lines on which the plurality of nodes of which the positions are changed is provided as a prediction frame obtained by predicting the non-reference frame; and
a difference detecting unit that detects a difference between pixel values of corresponding pixels in the prediction frame and the non-reference frame for respective pixels, wherein
the coding data output unit outputs the coding data that further includes the difference as a prediction error in prediction of the non-reference frame.

5. A decoding apparatus comprising:
a reference frame acquiring unit that acquires a reference frame from the reference frame segmented into a plurality of sub-regions in which a plurality of nodes is provided on boundary lines and a plurality of node motion vectors of which one end is at an optional one of the plurality of nodes from coding data; and
a prediction frame generator that changes the positions of the plurality of nodes along the node motion vector in the reference frame and generates a frame made up of sub-regions of which the boundary lines are formed by lines on which the plurality of nodes of which the positions are changed is provided as a prediction frame obtained by predicting frames other than the non-reference frame.

6. The decoding apparatus according to claim 5, further comprising:
a magnifying unit that changes the positions of the plurality of nodes in at least a portion of the reference frame and the prediction frame according to a set magnification ratio and generates a frame made up of new sub-regions of which the boundary lines are formed by lines on which the plurality of nodes of which the positions are changed is provided as a magnified frame.

7. The decoding apparatus according to claim 5, further comprising:
a masking processor that performs mask processing to generate a frame in which the sub-region designated as a masking target in any one of the reference frame and the prediction frame is masked; and
a frame combining unit that combines a combination target frame with the masked frame.

8. The decoding apparatus according to claim 5, further comprising:
an object recognizing unit that, when a feature amount of a recognition target object is designated, recognizes the recognition target object in the reference frame and the prediction frame based on the designated feature amount.

9. Coding data that includes a reference frame segmented into a plurality of regions in which a plurality of nodes is provided on boundary lines and a plurality of node motion vectors of which one end is at an optional one of the plurality of nodes.

10. A coding method comprising:
allowing a region segmentation unit to segment each of a plurality of frames in a coding target moving picture that includes the plurality of frames in a time-series order into a plurality of sub-regions having different feature amounts and to provide a plurality of nodes on a boundary line of each of the sub-regions;
allowing a motion vector detector to correlate each of the plurality of nodes on a reference frame serving as a reference among the plurality of frames with an optional node on a non-reference frame other than the reference frame and to detect a vector of which both ends are at the correlated node pair as a node motion vector for respective node pairs; and
allowing a coding data output unit to output data including the reference frame and the node motion vector as coding data obtained by coding the moving picture.

11. A decoding method comprising:
allowing a coding data acquiring unit to acquire data including a reference frame segmented into a plurality of sub-regions in which a plurality of nodes is provided on boundary lines and a plurality of node motion vectors of which one end is at an optional one of the plurality of nodes as coding data;
allowing a prediction frame generator to change the positions of the plurality of nodes along the node motion vector in the reference frame and to generate a frame made up of sub-regions of which the boundary lines are formed by lines on which the plurality of nodes of which the positions are changed is provided as a prediction frame obtained by predicting frames other than the non-reference frame.

12. A program for causing a computer to execute:
allowing a region segmentation unit to segment each of a plurality of frames in a coding target moving picture that includes the plurality of frames in a time-series order into a plurality of sub-regions having different feature amounts and to provide a plurality of nodes on a boundary line of each of the sub-regions;
allowing a motion vector detector to correlate each of the plurality of nodes on a reference frame serving as a reference among the plurality of frames with an optional node on a non-reference frame other than the reference frame and to detect a vector of which both ends are at the correlated node pair as a node motion vector for respective node pairs; and
allowing a coding data output unit to output data including the reference frame and the node motion vector as coding data obtained by coding the moving picture.

13. A program for causing a computer to execute:
allowing a coding data acquiring unit to acquire data including a reference frame segmented into a plurality of sub-regions in which a plurality of nodes is provided on boundary lines and a plurality of node motion vectors of which one end is at an optional one of the plurality of nodes as coding data;
allowing a prediction frame generator to change the positions of the plurality of nodes along the node motion vector in the reference frame and to generate a frame made up of sub-regions of which the boundary lines are formed by lines on which the plurality of nodes of which the positions are changed is provided as a prediction frame obtained by predicting frames other than the non-reference frame.
